(19) United States
(12) Patent Application Publication
(10) Pub. No.: US 2023/0013887 A1
(43) Pub. Date: Jan. 19, 2023

(54) SAMPLE OBSERVATION DEVICE, SAMPLE OBSERVATION METHOD, AND COMPUTER SYSTEM

(71) Applicant: Hitachi High-Tech Corporation, Tokyo (JP)

(72) Inventors: Akira ITO, Tokyo (JP); Atsushi MIYAMOTO, Tokyo (JP); Naoaki KONDO, Tokyo (JP); Hideki NAKAYAMA, Tokyo (JP)

(73) Assignee: Hitachi High-Tech Corporation, Tokyo (JP)

(21) Appl. No.: 17/864,773

(22) Filed: Jul. 14, 2022

(30) Foreign Application Priority Data
Jul. 14, 2021 (JP) 2021-116563

(51) Int. Cl. G06V 10/778; G06T 7/00

(52) U.S. Cl. CPC G06V 10/7788; G06T 7/0006; G06T 2207/10061; G06T 2207/30148; G06T 2207/20081

(57) ABSTRACT

In a learning phase, a processor of a sample observation device: stores design data on a sample in a storage resource; creates a first learning image as a plurality of input images; creates a second learning image as a target image; and learns a model related to image quality conversion with the first and second learning images. In a sample observation phase, the processor obtains, as an observation image, a second captured image output by inputting a first captured image obtained by imaging the sample with an imaging device to the model. The processor creates at least one of the first and second learning images based on the design data.

### BACKGROUND OF THE INVENTION

### 1. Field of the Invention

The present invention relates to a sample observation technique. As an example, the present invention relates to a device having a function of observing a defect, an abnormality, and so on (sometimes collectively referred to as defect) and a circuit pattern in a sample such as a semiconductor wafer.

### 2. Description of Related Art

In semiconductor wafer manufacturing, it is important to quickly start a manufacturing process and shift early to a high-yield mass production system. For this purpose, various inspection devices, observation devices, measuring devices, and so on are introduced in a production line. A sample observation device (also referred to as defect observation device) has a function of imaging a semiconductor wafer surface defect position with high resolution and outputting the image based on defect coordinates in defect position information inspected and output by an inspection device. The defect coordinates are coordinate information representing the position of a defect on a sample surface. In the sample observation device, a scanning electron microscope (SEM) or the like is used as an imaging device. Such sample observation devices are also called review SEMs and widely used.

Observation work automation is desired in semiconductor manufacturing lines. The review SEM includes, for example, automatic defect review (ADR) and automatic defect classification (ADC) functions. The ADR function is to perform, for example, processing to automatically collect images at sample defect positions indicated by defect coordinates in defect position information. The ADC function is to perform, for example, processing to automatically classify the defect images collected by the ADR function.

There are multiple types of circuit pattern structures formed on semiconductor wafers. Likewise, semiconductor wafer defects are various in type, occurrence position, and so on. As for the ADR function, it is important to capture and output a high-picture quality image with high defect visibility, circuit pattern visibility, and the like. Accordingly, in the related art, visibility enhancement is performed using an image processing technique with respect to a raw captured image that is a signal obtained from a detector of a review SEM and turned into an image.

By one method related thereto, the correspondence relationship between images different in image quality is pre-learned and an image of the other image quality is estimated based on the trained model when an image similar to one image quality is input. Machine learning or the like can be applied to the learning.

As an example of the related art related to the learning, JP-A-2018-137275 (Patent Document 1) describes a method for estimating a high-magnification image from a low-magnification image by pre-learning the relationship between the images captured at low and high magnifications.

In applying a method as described above for pre-learning the relationship between a captured image and an image of ideal image quality (also referred to as target image) with regard to the ADR function of a sample observation device, it is necessary to prepare the captured image (particularly plurality of captured images) and the target image for learning. However, it is difficult to prepare the image of ideal image quality in advance. For example, an actual captured image has noise, and it is difficult to prepare a noise-free image of ideal image quality based on the captured image.

In addition, the image quality of the captured image changes depending on, for example, the imaging environment or sample state difference. Accordingly, in order to perform more accurate learning, it is necessary to prepare a plurality of captured images of various image qualities. However, this requires a lot of effort. In addition, when learning is performed using a captured image, a sample needs to be prepared and imaged in advance, which imposes a heavy burden on a user.

There is a need for a mechanism capable of responding to, for example, a case where it is difficult to prepare multiple captured images or an image of ideal image quality and a mechanism capable of acquiring images of various image qualities suitable for sample observation.

### SUMMARY

An object of the present invention is to provide a technique for reducing work such as capturing an actual image with regard to sample observation device technique.

A typical embodiment of the present invention has the following configuration. A sample observation device according to the embodiment includes an imaging device and a processor. The processor: stores design data on a sample in a storage resource; creates a first learning image as a plurality of input images; creates a second learning image as a target image; learns a model related to image quality conversion with the first and second learning images; acquires, as an observation image, a second captured image output by inputting a first captured image obtained by imaging the sample with the imaging device to the model in observing the sample; and creates at least one of the first and second learning images based on the design data.

According to the typical embodiment of the present invention, provided is a technique for reducing work such as capturing an actual image with regard to sample observation device technique. Tasks, configurations, effects, and so on other than those described above are shown in the forms for carrying out the invention.

### BRIEF DESCRIPTION OF THE DRAWINGS

FIG. 1 is a diagram illustrating the configuration of a sample observation device according to a first embodiment of the present invention;

FIG. 2 is a diagram illustrating a learning phase and a sample observation phase in the first embodiment;

FIG. 3 is a diagram illustrating an example of defect coordinates in sample defect position information in the first embodiment;

FIG. 4 is a diagram illustrating the configuration of the learning phase in the first embodiment;

FIGS. 5A through 5C are diagrams illustrating examples of design data in the first embodiment;

FIG. 6 is a diagram illustrating the configuration of a learning phase in a second embodiment;

FIG. 7 is a diagram illustrating the configuration of a learning phase in a third embodiment;

FIG. 8 is a diagram illustrating, for example, collation between a captured image and design data in a fourth embodiment;

FIG. 9 is a diagram illustrating the configuration of a learning phase in a fifth embodiment;

FIG. 10 is a diagram illustrating the configuration of a plurality of detectors in the fifth embodiment;

FIGS. 11A through 11G are diagrams illustrating image examples in a first learning image in the fifth embodiment;

FIGS. 12H through 12J are diagrams illustrating image examples in the first learning image in the fifth embodiment;

FIGS. 13A through 13E are diagrams illustrating image examples in a second learning image in the fifth embodiment;

FIGS. 14F through 14K are diagrams illustrating image examples in the second learning image in the fifth embodiment;

FIG. 15 is a diagram illustrating the processing flow of the sample observation phase in each embodiment;

FIG. 16 is a diagram illustrating an example of dimension measurement processing in the sample observation phase in each embodiment;

FIG. 17 is a diagram illustrating an example of the processing of alignment with design data in the sample observation phase in each embodiment;

FIG. 18 is a diagram illustrating an example of the processing of defect detection and identification in the sample observation phase in each embodiment;

FIG. 19 is a diagram illustrating a GUI screen example in each embodiment; and

FIG. 20 is a diagram illustrating a GUI screen example in each embodiment.

### DESCRIPTION OF EMBODIMENTS

Hereinafter, embodiments of the present invention will be described in detail with reference to the drawings. In the drawings, the same parts are designated by the same reference numerals in principle, and repeated description thereof will be omitted. In the embodiments and the drawings, the representation of each component may not represent the actual position, size, shape, range, and so on to facilitate understanding of the invention. In the description, in describing processing by a program, the program, a function, a processing unit, and so on may be mainly described, but the main hardware therefor is a processor or a controller, a device, a computer, a system, or the like configured by the processor or the like. The computer executes processing in accordance with a program read out on a memory with the processor while appropriately using resources such as the memory and a communication interface. As a result, a predetermined function, processing unit, and so on are realized. The processor is configured by, for example, a semiconductor device such as a CPU and a GPU. The processor is configured by a device or circuit capable of performing a predetermined operation. The processing can also be implemented by a dedicated circuit without being limited to software program processing. FPGA, ASIC, CPLD, and so on can be applied to the dedicated circuit. The program may be pre-installed as data in the target computer or may be installed after being distributed as data from a program source to the target computer. The program source may be a program distribution server on a communication network, a non-transient computer-readable storage medium (e.g. memory card), or the like. The program may be configured by a plurality of modules. A computer system may be configured by a plurality of devices. The computer system may be configured by a client server system, a cloud computing system, an IoT system, or the like. Various data and information are represented and implemented in a structure such as a table and a list, but the present invention is not limited thereto. Representations such as identification information, identifiers, IDs, names, and numbers are mutually replaceable.

### EMBODIMENTS

Regarding a sample observation device, in image quality conversion based on machine learning (i.e. image estimation), preparing an image of target image quality is important for improving the performance of an image quality conversion engine (including learning model). In the embodiments, an image that matches user preference is used as a target image even in a case where an image that is difficult to realize with an actual captured image is a target image. In addition, in the embodiments, the performance of the image quality conversion engine is maintained even in a case where the image quality of an image fluctuates depending on the state of an observation sample and the like.

In the embodiments, a target image for learning (second learning image) is created based on a parameter in which a target image quality is designated by a user and design data. As a result, it is also possible to realize an image quality that is difficult to realize with an actual captured image and target image preparation is facilitated. In addition, in the embodiments, images of various image qualities (first learning images) are created based on design data. In the embodiments, those images are used as input images to optimize the model of the image quality conversion engine. In other words, a model parameter is set and adjusted to an appropriate value. As a result, robustness is improved against fluctuations in the image quality of an input image.

The sample observation device and method of the embodiments pre-create at least one of an image of a target image quality (second learning image) and input images of various image qualities (first learning images) based on sample design data and optimizes the model by learning. As a result, in observing a sample, a first captured image of the image quality obtained by actually imaging the sample is converted into a second captured image of ideal image quality by the model and the image is obtained as an observation image.

The sample observation device of the embodiments is a device for observing, for example, a circuit pattern or defect formed on a sample such as a semiconductor wafer. This sample observation device performs processing with reference to defect position information created and output by an inspection device. This sample observation device learns a model for estimating the second learning image, which is a target image of ideal image quality (image quality reflecting user preference), from the first learning images (plurality of input images), which are images captured by an imaging device or images created based on design data without imaging.

The sample observation device and method of the related art example are techniques for preparing multiple actually captured images and learning a model using the images as input and target images. On the other hand, the sample observation device and method of the embodiments are provided with a function of creating at least one of the first learning image and the second learning image based on design data. As a result, the work of imaging for learning can be reduced.

### First Embodiment

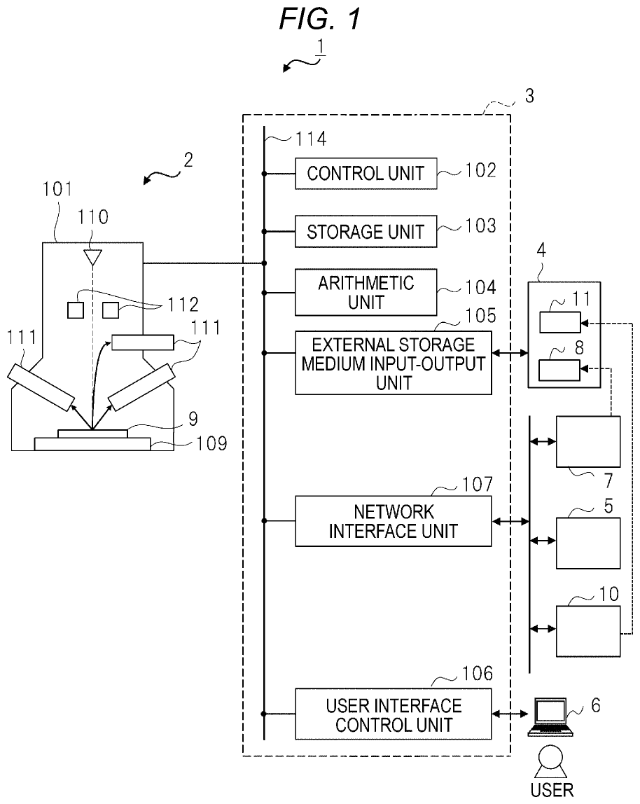

The sample observation device and so on of a first embodiment will be described with reference to FIGS. 1 to 5. The sample observation method of the first embodiment is a method including steps executed in the sample observation device of the first embodiment (particularly, processor of computer system). The processing in the sample observation device and the corresponding steps are roughly divided into learning processing and sample observation processing. The learning processing is model learning by machine learning. The sample observation processing is to perform sample observation, defect detection, and so on using an image quality conversion engine configured using a trained model.

In the first embodiment, each of the first learning image, which is an input image, and the second learning image, which is a target image, is an image created based on design data and is not an actually captured image.

Hereinafter, a device for observing, for example, a semiconductor wafer defect using a semiconductor wafer as a sample will be described as an example of the sample observation device. This sample observation device includes an imaging device that images a sample based on defect coordinates indicated by defect position information from an inspection device. An example of using an SEM as an imaging device will be described below. The imaging device is not limited to an SEM and may be a non-SEM device such as an imaging device using charged particles such as ions.

It should be noted that regarding the image qualities of the first learning image and the second learning image, the image quality (i.e. image properties) is a concept including a picture quality and other properties (e.g. partial extraction of circuit pattern). The picture quality is a concept including, for example, image magnification, field of view range, image resolution, and S/N. In the relationship between the image quality of the first learning image and the image quality of the second learning image, the high-low relationship of, for example, picture quality is a relative definition. For example, the second learning image is higher in picture quality than the first learning image. In addition, image quality-defining conditions, parameters, and so on are applied not only in a case where the image is obtained by performing imaging with an imaging device but also in a case where the image is created and obtained by image processing or the like.

The sample observation device and method of the first embodiment include a design data input unit inputting sample circuit pattern layout design data, a first learning image creation unit creating (i.e. generating) a plurality of first learning images of the same layout (i.e. same region) from the design data by changing a first processing parameter in a plurality of ways, a second learning image creation unit creating (i.e. generating) a second learning image from the design data using a second processing parameter designated by a user in accordance with user preference, a learning unit learning a model for estimating and outputting the second learning image using the plurality of first learning images as an input (i.e. learning unit learning model using first and second learning images), and an estimation unit inputting a first captured image of the sample imaged by an imaging device to the model and obtaining a second captured image as an output. The first learning image creation unit changes a parameter value in a plurality of ways with regard to at least one of the elements of sample circuit pattern shading value, shape deformation, image resolution, image noise, and so on to create the plurality of first learning images of the same region from the design data. The second learning image creation unit creates the second learning image from the design data using a parameter designated by the user on a GUI as a parameter different from a parameter for the first learning image.

[1-1. Sample Observation Device]

FIG. 1 illustrates the configuration of a sample observation device 1 of the first embodiment. The sample observation device 1 is roughly divided into and configured to have an imaging device 2 and a higher control device 3. The sample observation device 1 is a review SEM as a specific example. The imaging device 2 is an SEM 101 as a specific example. The higher control device 3 is coupled to the imaging device 2. The higher control device 3 is a device that controls, for example, the imaging device 2. In other words, the higher control device 3 is a computer system. Although the sample observation device 1 and so on are provided with necessary functional blocks and various devices, some thereof including an essential element are illustrated in the drawing. The whole including the sample observation device 1 of FIG. 1 is configured as a defect inspection system in other words. A storage medium device 4 and an input-output terminal 6 are connected to the higher control device 3. A defect classification device 5, an inspection device 7, a manufacturing execution system 10 (MES), and so on are connected to the higher control device 3 via a network.

The sample observation device 1 is a device or system that has an automatic defect review (ADR) function. In this example, defect position information 8 is created as a result of pre-inspecting a sample at the external inspection device 7. The defect position information 8 output and provided from the inspection device 7 is pre-stored in the storage medium device 4. The higher control device 3 reads out the defect position information 8 from the storage medium device 4 and refers to the defect position information 8 during defect observation-related ADR processing. The SEM 101 that is the imaging device 2 captures an image of a semiconductor wafer that is a sample 9. The sample observation device 1 obtains an observation image (particularly, plurality of images by ADR function) that is an image of ideal image quality reflecting user preference based on the image captured by the imaging device 2.

The manufacturing execution system (MES) 10 is a system that manages and executes a process for manufacturing a semiconductor device using the semiconductor wafer that is the sample 9. The MES 10 has design data 11 related to the sample 9. In this example, the design data 11 pre-acquired from the MES 10 is stored in the storage medium device 4. The higher control device 3 reads out the design data 11 from the storage medium device 4 and refers to the design data 11 during processing. The format of the design data 11 is not particularly limited insofar as the design data 11 is data representing a structure such as the circuit pattern of the sample 9.

The defect classification device 5 is a device or system that has an automatic defect classification (ADC) function. The defect classification device 5 performs ADC processing based on information or data that is the result of the defect observation processing by the sample observation device 1 using the ADR function and obtains a result in which defects (corresponding defect images) are classified. The defect classification device supplies the information or data that is the classification result to, for example, another network-connected device (not illustrated). It should be noted that the present invention is not limited to the configuration illustrated in FIG. 1. Also possible is, for example, a configuration in which the defect classification device 5 is merged with the sample observation device 1.

The higher control device 3 includes, for example, a control unit 102, a storage unit 103, an arithmetic unit 104, an external storage medium input-output unit 105 (i.e. input-output interface unit), a user interface control unit 106, and a network interface unit 107. These components are connected to a bus 114 and are capable of mutual communication, input, and output. It should be noted that although the example of FIG. 1 illustrates a case where the higher control device 3 is configured by one computer system, the higher control device 3 may be configured by, for example, a plurality of computer systems (e.g. plurality of server devices).

The control unit 102 corresponds to a controller that controls the entire sample observation device 1. The storage unit 103 stores various information and data including a program and is configured by a storage medium device including, for example, a magnetic disk, a semiconductor memory, or the like. The arithmetic unit 104 performs an operation in accordance with a program read out of the storage unit 103. The control unit 102 and the arithmetic unit 104 include a processor and a memory. The external storage medium input-output unit (i.e. input-output interface unit) 105 performs data input and output in relation to the external storage medium device 4.

The user interface control unit 106 is a part that provides and controls a user interface including a graphical user interface (GUI) for performing information and data input and output in relation to a user (i.e. operator). An input-output terminal 5 is connected to the user interface control unit 106. Another input or output device (e.g. display device) may be connected to the user interface control unit 106. The defect classification device 5, the inspection device 7, and so on are connected to the network interface unit 107 via a network (e.g. LAN). The network interface unit 107 is a part that has a communication interface controlling communication with an external device such as the defect classification device 5 via a network. A DB server or the like is another example of the external device.

A user inputs information (e.g. instruction or setting) to the sample observation device 1 (particularly, higher control device 3) using the input-output terminal 5 and confirms information output from the sample observation device 1. A PC or the like can be applied to the input-output terminal 5, and the input-output terminal 5 includes, for example, a keyboard, a mouse, and a display. The input-output terminal 5 may be a network-connected client computer. The user interface control unit 106 creates a GUI screen (described later) and displays the screen on the display device of the input-output terminal 5.

The arithmetic unit 104 is configured by, for example, a CPU, a ROM, and a RAM and operates in accordance with a program read out of the storage unit 103. The control unit 102 is configured by, for example, a hardware circuit or a CPU. In a case where the control unit 102 is configured by a CPU or the like, the control unit 102 also operates in accordance with the program read out of the storage unit 103. The control unit 102 realizes each function based on, for example, program processing. Data such as a program is stored in the storage unit 103 after being supplied from the storage medium device 4 via the external storage medium input-output unit 105. Alternatively, data such as a program may be stored in the storage unit 103 after being supplied from a network via the network interface unit 107.

The SEM 101 of the imaging device 2 includes, for example, a stage 109, an electron source 110, a detector 111, an electron lens (not illustrated), and a deflector 112. The stage 109 (i.e. sample table) is a stage on which the semiconductor wafer that is the sample 9 is placed, and the stage is movable at least horizontally. The electron source 110 is an electron source for irradiating the sample 9 with an electron beam. The electron lens (not illustrated) converges the electron beam on the sample 9 surface. The deflector 112 is a deflector for performing electron beam scanning on the sample 9. The detector 111 detects electrons and particles such as secondary and backscattered electrons generated from the sample 9. In other words, the detector 111 detects the state of the sample 9 surface as an image. In this example, a plurality of detectors are provided as the detector 111 as illustrated in the drawing.

The information (i.e. image signal) detected by the detector 111 of the SEM 101 is supplied to the bus 114 of the higher control device 3. The information is processed by, for example, the arithmetic unit 104. In this example, the higher control device 3 controls the stage 109 of the SEM 101, the deflector 112, the detector 111, and so on. It should be noted that a drive circuit or the like for driving, for example, the stage 109 is not illustrated. Observation processing is realized with respect to the sample 9 by the computer system that is the higher control device 3 processing the information (i.e. image) from the SEM 101.

This system may have the following form. The higher control device 3 is a server such as a cloud computing system, and the input-output terminal 5 operated by a user is a client computer. For example, in a case where a lot of computer resources are required for machine learning, machine learning processing may be performed in a server group such as a cloud computing system. A processing function may be shared between the server group and the client computer. The user operates the client computer, and the client computer transmits a request to the server. The server receives the request and performs processing in accordance with the request. For example, the server transmits data on a screen (e.g. web page) reflecting the result of the requested processing to the client computer as a response. The client computer receives the response data and displays the screen (e.g. web page) on a display device.

[1-2. Functional Blocks and Flows]

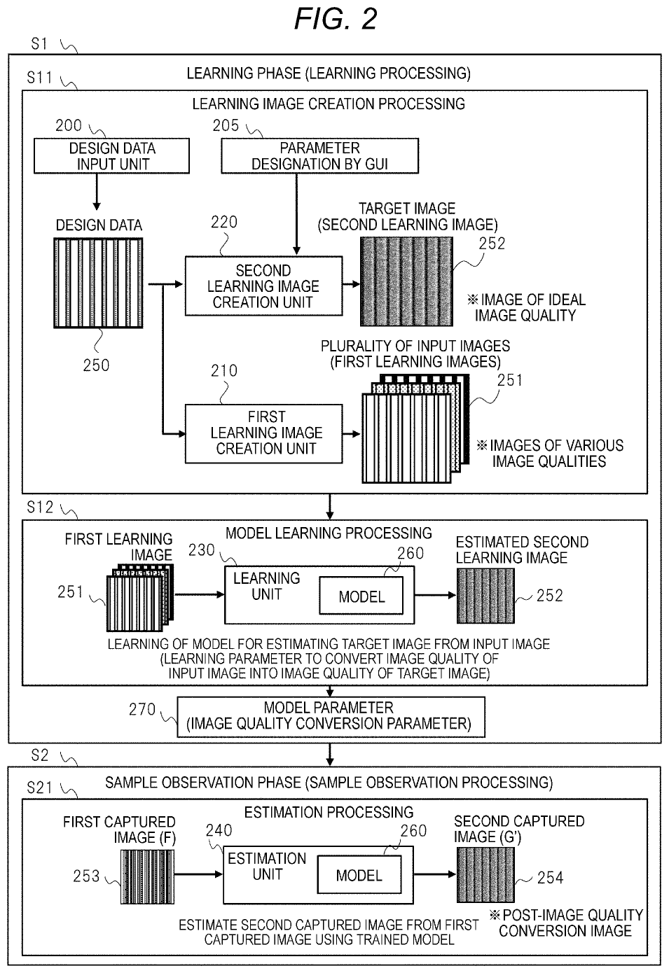

FIG. 2 illustrates a configuration example of main functional blocks and flows in the sample observation device and method of the first embodiment. The higher control device 3 of FIG. 1 realizes each functional block as in FIG. 2 by the processing of the control unit 102 or the arithmetic unit 104. The sample observation method is roughly divided into and includes a learning phase (learning processing) S1 and a sample observation phase (sample observation processing) S2. The learning phase S1 includes a learning image creation processing step S11 and a model learning processing step S12. The sample observation phase S2 includes an estimation processing step S21. Each part corresponds to each step. Data and information such as various images, models, setting information, and processing results are appropriately stored in the storage unit 103 of FIG. 1.

The learning image creation processing step S11 has a design data input unit 200, parameter designation 205 by GUI, a second learning image creation unit 220, and a first learning image creation unit 210 as functional blocks. The design data input unit 200 inputs design data 250 from the outside (e.g. MES 10) (e.g. reads the design data 11 from the storage medium device 4 of FIG. 1). The parameter designation 205 by GUI is for a user to designate and input a parameter related to the creation of the second learning image (also described as second processing parameter) on a GUI screen (described later). The second learning image creation unit 220 creates the second learning image that is a target image 252 based on the design data 250 and the second processing parameter. The first learning image creation unit 210 creates the first learning images that are a plurality of input images 251 based on the design data 250. It should be noted that the creation of the first learning image and the second learning image may be, for example, using the image of the design data itself in a case where the design data is an image and, in a case where the design data is vector data, creating a bitmap image from the vector data.

In the model learning processing S12, a model 260 is trained such that the target image 252 that is the second learning image (estimated second learning image) is output no matter which of the plurality of input images 251 that are the first learning images (images of various image qualities) is input.

[1-3. Defect Position Information]

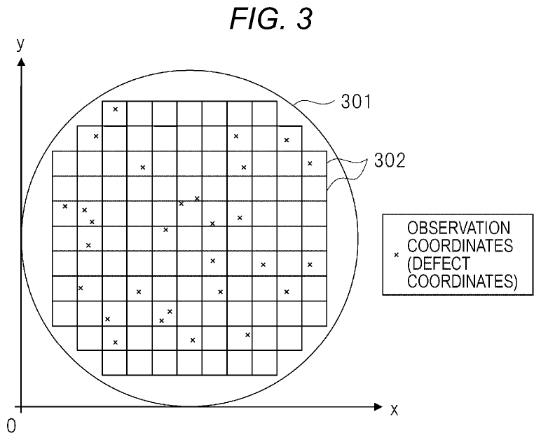

FIG. 3 is a schematic diagram illustrating an example of a defect position indicated by the defect coordinates in the defect position information 8 from the external inspection device 7. In FIG. 3, the defect coordinates are illustrated by points (x marks) on the x-y plane of the target sample 9. When viewed from the sample observation device 1, the defect coordinates are observation coordinates to be observed. A wafer 301 indicates a circular semiconductor wafer surface region. Dies 302 indicate the regions of the plurality of dies (i.e. chips) formed on the wafer 301.

The sample observation device 1 of the first embodiment has an ADR function to automatically collect a high-definition image showing a defect part on the surface of the sample 9 based on such defect coordinates. However, the defect coordinates in the defect position information 8 from the inspection device 7 include an error. In other words, an error may occur between the defect coordinates in the coordinate system of the inspection device 7 and the defect coordinates in the coordinate system of the sample observation device 1. Examples of the cause of the error include imperfect alignment of the sample 9 on the stage 109.

Accordingly, the sample observation device 1 captures a low-magnification image with a wide field of view (i.e. image of relatively low picture quality, first image) under a first condition centering on the defect coordinates of the defect position information 8 and re-detects the defect part based on the image. Then, the sample observation device 1 estimates a high-magnification image with a narrow field of view (i.e. image of relatively high picture quality, second image) under a second condition regarding the re-detected defect part using a pre-trained model and acquires the image as an observation image.

The wafer 301 includes the plurality of regular dies 302. Accordingly, in a case where, for example, another die 302 adjacent to the die 302 that has a defect part is imaged, it is possible to acquire an image of a non-defective die that includes no defect part. In the defect detection processing in the sample observation device 1, for example, such a non-defective die image can be used as a reference image. Further, in the defect detection processing, for example, shading (example of feature quantity) comparison as a defect determination is performed between the inspection target image (observation image) and the reference image and a part different in shading can be detected as a defect part.

[1-4. Learning Phase 1]

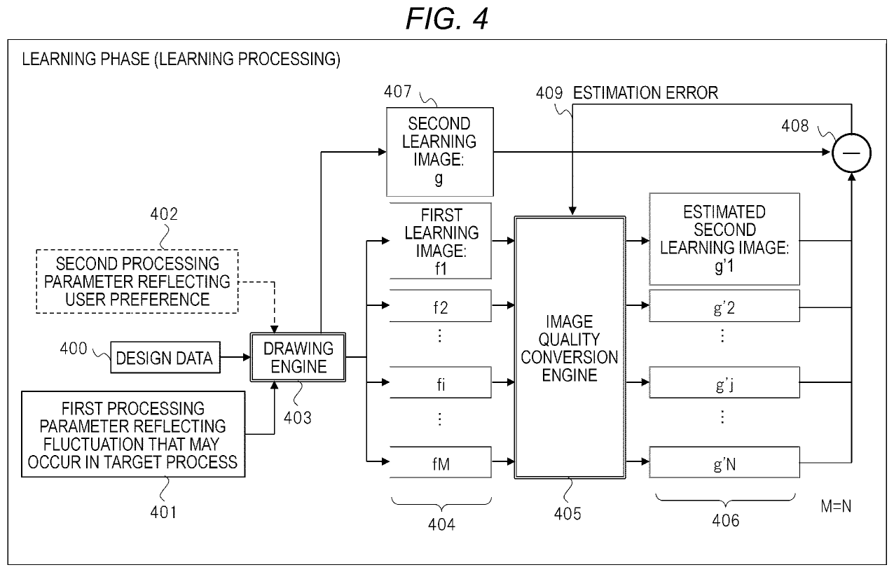

FIG. 4 illustrates a configuration example of the learning phase S1 in the first embodiment. The processor (control unit 102 or arithmetic unit 104) of the higher control device 3 performs the processing of the learning phase S1. A drawing engine 403 corresponds to a processing unit that has both the first learning image creation unit 210 and the second learning image creation unit 220 in FIG. 2. An image quality conversion engine 405 corresponds to a learning unit 230 that performs learning using the model 260 in FIG. 2.

In the learning phase S1, the processor acquires first learning images 404 by inputting data obtained by cutting out a part of the region of design data 400 and a first processing parameter 401 to the drawing engine 403. The first learning images 404 are a plurality of input images for learning. Here, this image is also indicated by the symbol f. i is 1 to M, and M is an image count. The plurality of first learning images are indicated as f={f1, f2, . . . , fi, . . . , fM}.

The first processing parameter 401 is a parameter (i.e. condition) for creating (i.e. generating) the first learning image 404. In the first embodiment, the first processing parameter 401 is a parameter preset in this system. The first processing parameter 401 is a parameter set for creating the plurality of first learning images of different image qualities by assuming a change in the image quality of the captured image attributable to the imaging environment or the state of the sample 9. The first processing parameter 401 is a parameter set that is set by changing a parameter value in a plurality of ways using the parameter of at least one of the elements of circuit pattern shading value, shape deformation, image resolution, image noise, and so on.

The design data 400 is layout data on the circuit pattern shape of the sample 9 to be observed. For example, in a case where the sample 9 is a semiconductor wafer or a semiconductor device, the design data 400 is a file in which edge information on the design shape of the semiconductor circuit pattern is written as coordinate data. In the related art, a format such as GDS-II and OASIS is known as such a design data file. By using the design data 400, it is possible to obtain pattern layout information without actually imaging the sample 9 with the SEM 101.

The drawing engine 403 creates both the first learning image 404 and a second learning image 407 as images based on the layout information on the pattern in the design data 400.

In the first embodiment (FIG. 4), the first processing parameter 401 for the first learning image and the second processing parameter for the second learning image are different parameters. As for the first processing parameter 401, with fluctuations in the target process taken into consideration, a change in parameter value corresponding to the elements of circuit pattern shading, shape deformation, image resolution, and image noise is reflected and preset. On the other hand, a second processing parameter 402 reflects a parameter value designated by a user on a GUI and reflects user preference in observing a sample.

[1-5. Design Data)]

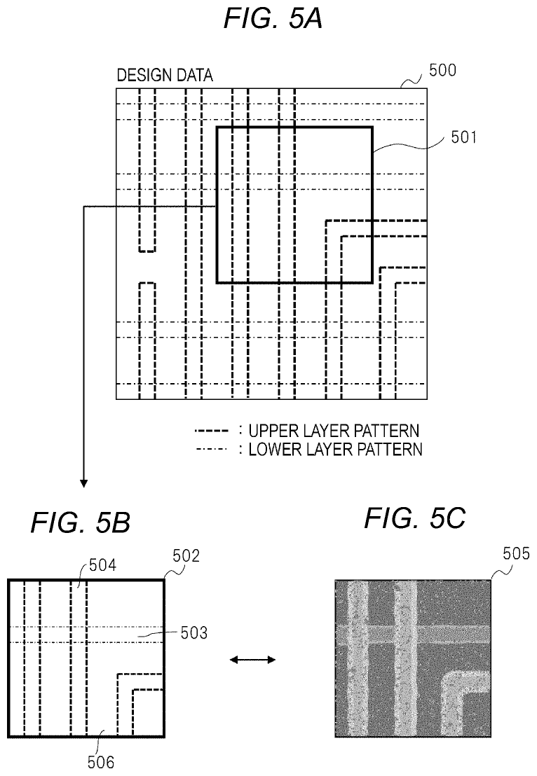

The layout information on the pattern in the design data 400 will be described with reference to FIG. 5. FIG. 5 illustrates an example of the layout information on the pattern in the design data 400. Design data 500 in FIG. 5A illustrates design data on a certain region on the surface of the sample 9. The layout information on the pattern of each region can be acquired from the design data 400. In this example, the edge shape of the pattern is represented by a line. For example, the thick dashed line indicates an upper layer pattern, and the one-dot chain line indicates a lower layer pattern. A region 501 indicates an example of a pattern region to be compared for description.

An image 505 in FIG. 5C is an image acquired by actually imaging the same region as the region 501 on the surface of the sample 9 with the SEM 101, which is an electron microscope.

Information (region) 502 in FIG. 5B is information (region) obtained by trimming the region 501 (same region as image 505) from the design data 500 in FIG. 5A. A region 504 is an upper layer pattern region (e.g. vertical line region), and a region 503 is a lower layer pattern region (e.g. horizontal line region). For example, the vertical line region that is the region 504 has two vertical lines (thick broken lines) as an edge shape as illustrated in the drawing. Such a pattern region has, for example, coordinate information for each configuration point (corresponding pixel).

Examples of how an image is acquired in the drawing engine 403 include drawing in order from the lower layer based on the pattern layout information acquired from the design data 400 and a processing parameter. The drawing engine 403 trims the region to be drawn (e.g. region 501) from the design data 500 and draws a pattern-less region (e.g. region 506) based on the processing parameter (first processing parameter 401). Next, the drawing engine 403 draws the region 503 of the lower layer pattern and, finally, draws the region 504 of the upper layer pattern to obtain an image such as the information 502. The first learning image 404 of FIG. 4 is obtained as a result of such processing. By performing similar processing while changing the parameter value or the like, the first learning images 404 that are the plurality of input images can be obtained.

[1-6. Learning Phase 2]

Returning to FIG. 4, next, the processor acquires a second learning image 407 by inputting data obtained by cutting out the same region as when the first learning image 404 is acquired to the drawing engine 403 based on the second processing parameter 402 and the design data 400. The second processing parameter 402 is a parameter set for creating (i.e. generating) the second learning image 407 and is a parameter designated by a user using a GUI or the like and reflecting user preference.

Next, the processor obtains estimated second learning images 406 as an output by estimation by inputting the first learning images 404, which are a plurality of input images, to the image quality conversion engine 405. The estimated second learning image 406 is an image estimated by a model. Here, this image is also indicated by the symbol g′. j is 1 to N, and N is an image count. The plurality of estimated second learning images are indicated as g′={g′1, g′2, . . . , g′j, . . . , g′N}.

It should be noted that in the first embodiment, the number M of the first learning images (f) 404 and the number N of the estimated second learning images (g′) 406 are equal to each other, but the present invention is not limited thereto.

A deep learning model such as a model represented by a convolutional neural network (CNN) may be applied as the machine learning model of the image quality conversion engine 405.

Next, in an operation 408, the processor inputs the second learning image (g) 407 and the plurality of estimated second learning images (g′) 406 to calculate an estimation error 409 regarding the difference therebetween. The calculated estimation error 409 is fed back to the image quality conversion engine 405. The processor updates the parameter of the model of the image quality conversion engine 405 such that the estimation error 409 decreases.

The processor optimizes the image quality conversion engine 405 by repeating the learning processing as described above. The optimized image quality conversion engine 405 means that the accuracy in estimating the estimated second learning image 406 from the first learning image 404 is high. It should be noted that an image difference or an output by a CNN identifying the second learning image 407 and the estimated second learning image 406 may be used for the estimation error 409. As a modification example, in the latter case, the operation 408 is an operation by learning using a CNN.

A task of this processing is how to acquire the first learning image 404 and the second learning image 407. In order to optimize the image quality conversion engine 405 to be robust against a change in the image quality of a captured image attributable to the state of the sample 9 or imaging condition difference, it is necessary to ensure a variation in the image quality of the first learning image 404. In this regard, in this processing, a change in image quality that may occur is assumed, the first processing parameter 401 is changed in a plurality of ways, and the first learning image 404 is created from the design data 400. As a result, it is possible to ensure a variation in the image quality of the first learning image 404.

In addition, in order to optimize the image quality conversion engine 405 so as to be capable of outputting an image of an image quality reflecting user preference, it is necessary to use an image of an image quality reflecting user preference as the second learning image 407 that is a target image. However, in a case where it is difficult to realize an image quality that matches user preference (i.e. image quality suitable for observation) with an image obtained by imaging the sample 9, it is difficult to prepare such a target image. In this regard, in this processing, the second learning image 407 is created by inputting the design data 400 and the second processing parameter 402 to the drawing engine 403. As a result, an image of an image quality that is difficult to realize with a captured image can also be acquired as the second learning image 407. In addition, in this processing, both the first learning image 404 and the second learning image 407 are created based on the design data 400. Accordingly, in the first embodiment, it is basically unnecessary to prepare and image the sample 9 in advance and the image quality conversion engine 405 can be optimized by learning.

It should be noted that in the sample observation device 1 of the first embodiment, it is unnecessary to use an image captured by the SEM 101 for the learning processing, but there is no limitation on using an image captured by the SEM 101 in the learning or sample observation processing. For example, as a modification example, some captured images may be added and used as an auxiliary in the learning processing.

It should be noted that the first processing parameter 401 is pre-designed as a parameter reflecting a fluctuation that may occur in a target process. This target process is the manufacturing process of a manufacturing process corresponding to the type of the target sample 9. The fluctuation is a fluctuation in environment, state, or condition related to an image quality (e.g. resolution, pattern shape, noise, and so on).

In the first embodiment, the first processing parameter 401 related to the first learning image 404 is pre-designed in this system, but the present invention is not limited thereto. In a modification example, the first processing parameter as well as the second processing parameter may allow variable setting by a user on a GUI screen. For example, a parameter set or the like to be used as the first processing parameter may allow selection from candidates and setting. In particular, on the GUI screen in a modification example, a fluctuation range (or statistical value of dispersion or the like) may be settable for each employed parameter regarding the first processing parameter for ensuring an image quality variation. As a result, a user can make trials and adjustments by variable first processing parameter setting while taking the trade-off between the processing time and accuracy into consideration.

[1-7. Effect, and the Like]

As described above, according to the sample observation device and method of the first embodiment, it is possible to reduce work such as capturing an actual image. In the first embodiment, the first learning image and the second learning image can be created using the design data without using an actual captured image. As a result, it is unnecessary to prepare and image a sample prior to sample observation and it is possible to optimize the model of the image quality conversion engine offline, that is, without imaging. Accordingly, for example, learning can be performed at design data completion and the first captured image can be captured and the second captured image can be estimated as soon as a semiconductor wafer as a target sample is completed. In other words, the efficiency of the entire work can be improved.

According to the first embodiment, it is possible to optimize the image quality conversion engine capable of conversion into an image quality matching user preference. In addition, the image quality conversion engine can be optimized to be highly robust against a change in sample state or imaging conditions. As a result, using this image quality conversion engine in observing a sample, it is possible to stably and highly accurately output an image of an image quality matching user preference as an observation image.

According to the first embodiment, multiple images can be prepared even in a case where deep learning is used as machine learning. According to the first embodiment, a target image corresponding to user preference can be created. According to the first embodiment, an input image corresponding to various imaging conditions is created from design data, a target image is created by a user performing parameter designation, and thus the above effects can be achieved.

### Second Embodiment

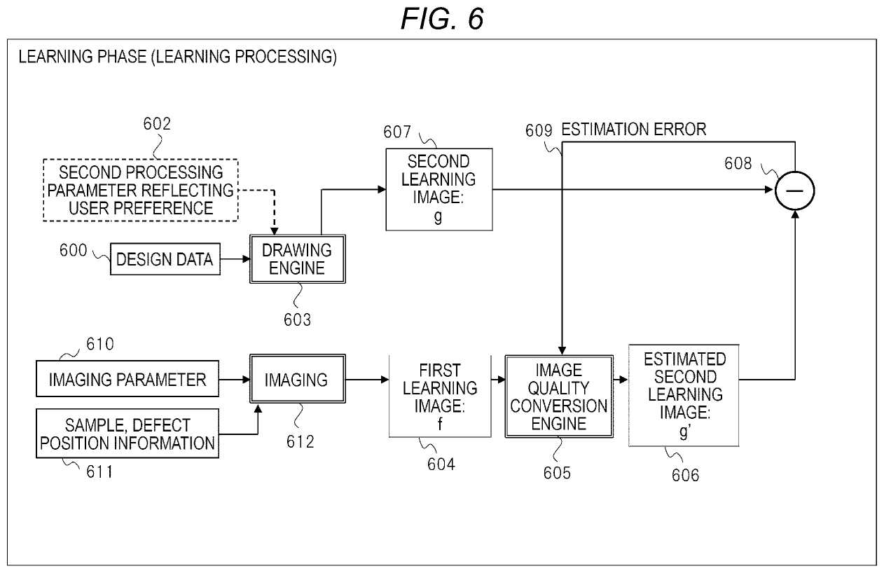

The sample observation device and so on according to a second embodiment will be described with reference to FIG. 6. The second embodiment and so on are similar in basic configuration to the first embodiment. Hereinafter, configuration parts in the second embodiment and so on that are different from those of the first embodiment will be mainly described. The sample observation device and method of the second embodiment include a design data input unit inputting sample circuit pattern layout design data, a first learning image input unit preparing a first learning image, a second learning image creation unit creating a second learning image from design data using a second processing parameter designated by a user, a learning unit learning a model using the first learning image and the second learning image, and an estimation unit inputting a first captured image of the sample imaged by an imaging device to the model and outputting a second captured image by estimation.

In the second embodiment, a task of this processing is how to acquire an ideal target image matching user preference. It is not easy to image a sample while changing the imaging conditions of an imaging device and figure out the imaging conditions of an image matching user preference. Further, under any imaging conditions, it may be impossible to obtain an image of ideal image quality anticipated by a user. In other words, not all evaluation values such as image resolution, signal/noise ratio (S/N), and contrast can be as desired as electron microscopic imaging has its own physical limitations.

In this regard, in the second embodiment, design data is input to a drawing engine, drawing is performed using the second processing parameter reflecting user preference, and a target image of ideal image quality can be created as a result. The ideal target image created from the design data is used as the second learning image.

As for the configuration of the learning phase S1 in the second embodiment that is different from FIG. 2, the first learning image creation unit 210 creates the plurality of input images 251 based on images actually captured by the imaging device 2 without creating the plurality of input images 251 from the design data 250.

[2-1. Learning Phase]

FIG. 6 illustrates a configuration example of the learning phase S1 in the second embodiment. According to the method of the first embodiment described above, in the learning phase S1, both the first learning image 404 and the second learning image 407 of FIG. 4 are created based on design data and the image quality conversion engine 405 is optimized. On the other hand, in the second embodiment, an image actually captured by the SEM 101, which is an electron microscope, is used regarding the first learning image and the second learning image is created based on design data.

In FIG. 6, the processor sets an imaging parameter 610 of the SEM 101 and performs imaging 612 of the sample 9 under the control of the SEM 101. At this time, the processor may use the defect position information 8. The processor acquires at least one image as a first learning image (f) 604 by this imaging 612.

It should be noted that in the second embodiment, the imaging 612 by the imaging device 2 is not limited to an electron microscope such as the SEM 101 and an optical microscope, an ultrasonic inspection device, or the like may be used.

However, in a case where a plurality of images of various image qualities assuming a change in image quality that may occur are acquired as the first learning images 604 by the imaging 612, in the related art, a plurality of samples corresponding thereto are necessary, which causes a heavy work burden on a user. Accordingly, in the second embodiment, the processor may create and acquire a plurality of input images of variously changed image qualities as the first learning images by applying image processing in which a parameter value is variously changed with respect to one first learning image 604 obtained by the imaging 612.

Next, the processor acquires a second learning image 607 (g) by inputting design data 600 and a second processing parameter 602, which is a processing parameter reflecting user preference, to a drawing engine 603. The drawing engine 603 corresponds to the second learning image creation unit.

[2-2. Effect, and the Like]

As described above, according to the second embodiment, the second learning image, which is a target image, is created based on design data, and thus the work of imaging for target image creation can be reduced.

In addition, other effects include the following. In the first embodiment described above (FIG. 2), the input image (first learning image) of the learning phase S1 is created from design data and the input image of the sample observation phase S2 is a captured image (first captured image 253). Accordingly, in the first embodiment, the difference between the created image based on the design data and the captured image may have an effect in the learning phase S1 and the sample observation phase S2. On the other hand, in the second embodiment, the input image of the learning phase S1 is created from a captured image and the input image of the sample observation phase S2 is also a captured image (first captured image 253). As a result, unlike in the learning phase S1 in the first embodiment, in the learning phase S1 in the second embodiment, the model can be optimized without being affected by the difference between the created image acquired by the drawing engine based on the design data and the captured image.

### Third Embodiment

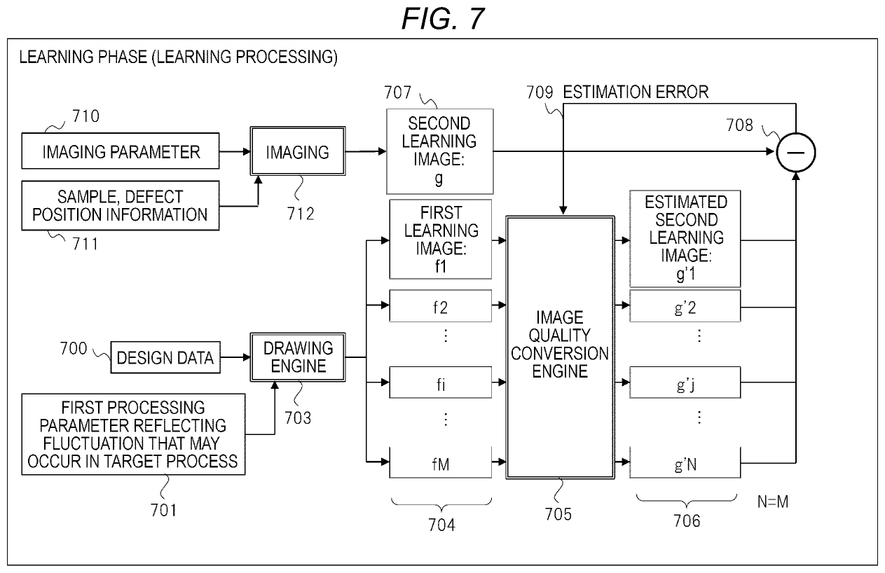

The sample observation device and so on according to a third embodiment will be described with reference to FIG. 7. The sample observation device and method of the third embodiment include a design data input unit inputting sample circuit pattern layout design data, a first learning image creation unit creating a first learning image, a second learning image input unit preparing a second learning image, a learning unit learning a model using the first learning image and the second learning image, and an estimation unit inputting a first captured image of the sample imaged by an imaging device to the model and outputting a second captured image by estimation.

The first learning image creation unit changes the first processing parameter of at least one of the elements of circuit pattern shading value, shape deformation, image resolution, image noise, and so on in a plurality of ways to create a plurality of input images of the same region as the first learning images from the design data.

In the third embodiment, a task of this processing is to use images of various image qualities as the first learning images. If only an image of single image quality is used as the first learning image, it is difficult to ensure robustness against a change in image quality attributable to the sample state or imaging condition difference, and thus the versatility of the image quality conversion engine is low. In the third embodiment, in creating the first learning image from the same design data, the first processing parameter is changed assuming a change in image quality that may occur, and thus it is possible to ensure a variation in the image quality of the first learning image.

As for the configuration of the learning phase S1 in the third embodiment that is different from FIG. 2, the second learning image creation unit 220 creates the target image 252 based on an image actually captured by the imaging device 2 without creating the target image 252 from the design data 250.

[3-1. Learning Phase]

FIG. 7 illustrates a configuration example of the learning phase S1 in the third embodiment. In the third embodiment, an image captured by the imaging device 2 (SEM 101) is used regarding the second learning image and the first learning image is created based on design data.

In FIG. 7, the processor acquires a second learning image 707 (g) by setting an imaging parameter 710 of the SEM 101 that is the imaging device 2 and controlling imaging 712 of the sample 9. The processor may use the defect position information 8 during the imaging 712.

It should be noted that the image acquired by the imaging 712 may lack visibility due to the effect of insufficient contrast, noise, or the like. Accordingly, in the third embodiment, the processor may apply image processing such as contrast correction and noise removal to the image obtained by the imaging 712 and use the image as the second learning image 707. In addition, the processor of the sample observation device 1 may use an image acquired from another external device as the second learning image 707.

Next, the processor acquires first learning images 704 (f), which are a plurality of input images, by inputting design data 700 and a first processing parameter 701 to a drawing engine 703.

It should be noted that the first processing parameter 701 is a parameter set for acquiring the first learning images 704, which are a plurality of input images of different image qualities, by changing a parameter value in a plurality of ways regarding the parameter of at least one of the elements of circuit pattern shading value, shape deformation, image resolution, and image noise by assuming a change in the image quality of the captured image attributable to the imaging environment or the state of the sample 9.

In general, in a case where an image of satisfactory image quality is acquired by electron microscopic imaging, the time required for processing such as imaging increases. For example, the imaging takes a relatively long time as electron beam scanning, addition processing on a plurality of image frames, and so on are required. Accordingly, in that case, it is difficult to achieve picture quality and processing time at the same time and there is a trade-off relationship between picture quality and processing time.

In this regard, in this processing in the third embodiment, the imaging 712 of an image of satisfactory picture quality is performed in advance and the image is used for learning of an image quality conversion engine 705 as the second learning image 707. As a result, conversion is possible from an image of relatively poor picture quality to an image of relatively satisfactory picture quality although the imaging processing time is relatively short. As a result, it is possible to achieve picture quality and processing time at the same time. In other words, it is easy to adjust the balance between picture quality and processing time depending on the user.

In addition, in the case of a modification example in which an image acquired by another device is used as the second learning image 707, in the sample observation phase S2, the image quality of the image captured by the sample observation device 1 can be converted into the image quality of the image acquired by the other device.

It should be noted that in FIG. 7, when the imaging 712 by the SEM 101 is controlled by the imaging parameter 710 from the processor of the higher control device 3, for example, the number of times of electron beam scanning or the like is set and controlled. As a result, it is possible to control, for example, the level of the picture quality of the captured image. For example, the scanning count can be increased to capture an image of high picture quality on the target image (second learning image 707) side and an image of relatively low picture quality can be used based on the design data 700 on the input image (first learning image 704) side. By controlling the level of picture quality between the input image and the target image in this manner, it is possible to balance processing time and accuracy.

[3-2. Effect, and the Like]

As described above, according to the third embodiment, the first learning images, which are a plurality of input images, are created based on design data, and thus the work of imaging for creating a plurality of input images can be reduced.

### Fourth Embodiment

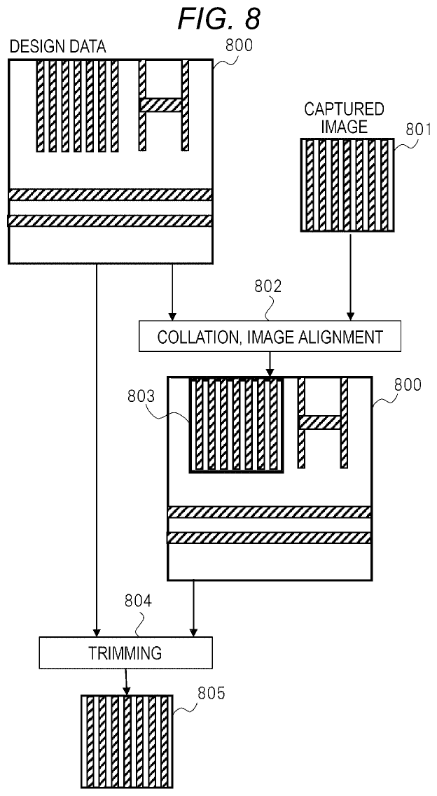

The sample observation device and so on according to a fourth embodiment will be described with reference to FIG. 8. In the fourth embodiment, a method for using the first learning image and the second learning image will be described. In the fourth embodiment, a captured image is used as one of the first learning image and the second learning image. Accordingly, the fourth embodiment corresponds to a modification example of the second embodiment or the third embodiment. As for configuration parts, the fourth embodiment differs from the learning phases S1 in the second and third embodiments mainly in how a learning image is acquired and used.

[4-1. Learning Phase]

FIG. 8 illustrates a configuration example of the learning phase S1 in the fourth embodiment. In the fourth embodiment, one of the first learning image (f) and the second learning image (g) is a captured image of the sample 9 imaged by the SEM 101 and the other is a design image created from design data. For example, although a case where the first learning image is created from the captured image and the second learning image is created from the design data will be described, the processing in the fourth embodiment is similarly established in the opposite case as well.

In FIG. 8, the processor collates an image 801 captured by the SEM 101 with design data 800 and performs image alignment processing 802. Based on this processing 802, the processor performs trimming 804 on a position and region 803 corresponding to the position and region of the captured image 801 in the region of the design data 800. As a result, trimmed design data 805 (region, information) is obtained. The processor creates the first learning image or the second learning image from the design data 805 (region).

It should be noted that in a case where the function of the image alignment 802 as described above is provided, in the case of the second embodiment of FIG. 6, for example, a functional block performing image alignment is added using the captured image obtained by the imaging 612 by the SEM 101 and the design data 600 (region therein) as inputs.

In the fourth embodiment, the first learning image and the second learning image can be aligned by this processing and there is no misalignment or misalignment is reduced regarding the first learning image and the second learning image. As a result, it is possible to optimize the model without taking misalignment between the first learning image and the second learning image into consideration and the stability of the optimization processing is improved.

### Fifth Embodiment

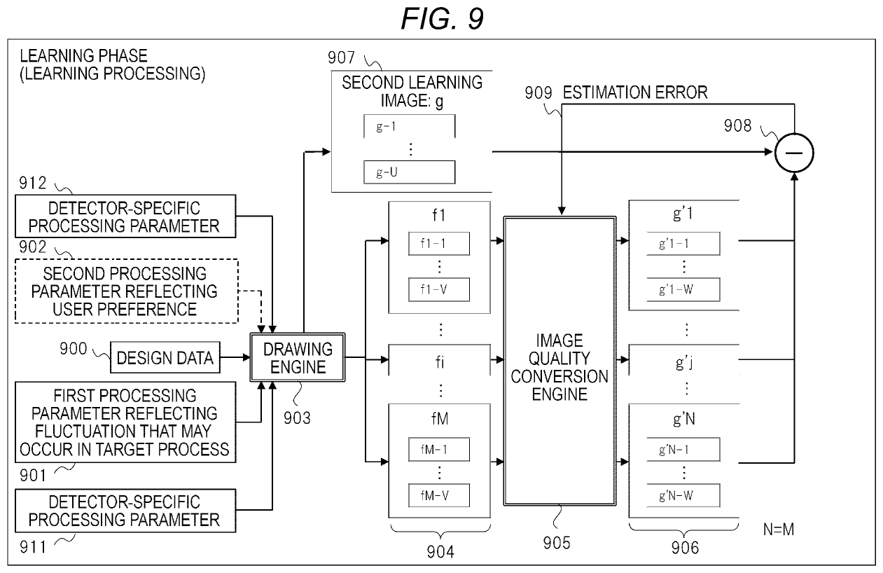

The sample observation device and so on according to a fifth embodiment will be described with reference to the drawings starting from FIG. 9. Described in the fifth embodiment is a method for using a plurality of images in the first learning image and the second learning image, that is, a method for further performing pluralization for each image described above. As for configuration parts, the fifth embodiment differs from the first embodiment mainly in how a learning image is acquired and used. In the fifth embodiment, a plurality of images are further used for each same region of the sample 9 regarding the first learning image and the second learning image in the first embodiment. The features of the fifth embodiment can be similarly applied to the first to third embodiments.

[5-1. Learning Phase]

FIG. 9 illustrates a configuration example of the learning phase S1 in the fifth embodiment. A drawing engine 903 creates a plurality of first learning images 904 based on design data 900, a first processing parameter 901, and a detector-specific processing parameter 911. In addition, the drawing engine 903 creates a second learning image 907 based on the design data 900, a second processing parameter 902, and a detector-specific processing parameter 912. Further, in the fifth embodiment, each first learning image 904 is configured by a plurality of images and the second learning image 907 is configured by a plurality of images. For example, a first image f1 in the first learning images 904 is configured by a plurality of (referred to as V) images from f1−1 to f1−V. Likewise, each image up to the Mth is configured by a plurality of (V) images. The second learning image 907 (g) is configured by a plurality of (referred to as U) images from g−1 to g−U.

Each image in the plurality of first learning images 904 (f1 to fM) acquired by the drawing engine 903 can be treated as a two-dimensional array. For example, in a certain rectangular image, the screen horizontal direction (x direction) can be the first dimension, the screen vertical direction (y direction) can be the second dimension, and then the position of each pixel in the image region can be designated in the two-dimensional array. Further, as for the configuration of the first learning images 904 (images of two-dimensional array), which are a plurality of input images, each image may be expanded into a three-dimensional array by connecting the directions corresponding to the image count V as three-dimensional directions. For example, the first image group f1 (=f1−1 to f1−V) is configured by one three-dimensional array.

The plurality of first learning images 904 (f1 to fM) can be identified and specified as follows corresponding to the image count M and the image count V. i is used as a variable (index) for identifying a plurality in the direction corresponding to the image count M, and m is used as a variable (index) for identifying a plurality in the direction corresponding to the image count V. Of the first learning images 904, a certain image can be specified by designating (i, m). For example, the image can be specified as the mth image fi−m of the ith image group fi={fi−1, . . . , fi−V}, which is the first learning images 904.

In addition, each image in the plurality of second learning images 907 {g−1, . . . , g−U} acquired by the drawing engine 903 can be treated as a two-dimensional array. Further, as for the configuration of the second learning images 907 (images of two-dimensional array), which are a plurality of target images, each image may be expanded into a three-dimensional array by connecting the directions corresponding to the image count U as three-dimensional directions. Of the second learning images 907 (g−1 to g−U), which are a plurality of target images, one image can be specified as, for example, an image g-k using a variable (referred to as k) for identifying a plurality in a direction corresponding to the image count U.

Next, by inputting each image (e.g. image group f1) of the first learning image 904 to an image quality conversion engine 905, the corresponding image group (e.g. g′1) is obtained as an estimated second learning image 906. Regarding this estimated second learning image 906 as well, the processor may perform division into a plurality of elements in a direction (e.g. three-dimensional direction) corresponding to an image count (referred to as W) different from the image count N to create, for example, the image group g′1 {g′1−1, . . . , g′1−W}. These estimated second learning images 906 may also be configured by three-dimensional arrays.

The plurality of second learning images 906 (g′1 to g′N) can be, for example, identified and specified as follows corresponding to the image count N and the image count W. j is used as a variable (index) in the direction corresponding to the image count N, and n is used as a variable (index) in the direction corresponding to the image count W. Of the plurality of second learning images 906, a certain image can be specified by designating (j, n). For example, the image can be specified as the nth image g′j−n of the jth image group g′j={g′j−1, . . . , g′j−W}, which is the second learning images 906.

It should be noted that in the fifth embodiment, in the example of FIG. 9, a case where both the first learning image 904 and the second learning image 907 are created based on the design data 900 is illustrated, but the present invention is not limited thereto. As in the second and third embodiments, one of the first learning image 904 and the second learning image 907 may be acquired by imaging the sample 9.

In addition, in the fifth embodiment, with respect to the first to fourth embodiments described above, the model of the image quality conversion engine 905 is changed to a configuration inputting and outputting a multidimensional image corresponding to the image counts (V, W) in the three-dimensional direction of the first learning image 904 and the estimated second learning image 906. For example, in a case where a CNN is applied to the image quality conversion engine 905, simply the input and output layers in the CNN may be changed to the configuration corresponding to the image counts (V, W) in the three-dimensional direction.

In the fifth embodiment, it is possible to apply, for example, a plurality of images of a plurality of types that can be acquired by the plurality of detectors 111 (FIG. 1) of the imaging device 2 (SEM 101) in particular as the plurality of images (e.g. images f1−1 to f1−V of image group f1) in the image counts (V, W) in the three-dimensional direction. The plurality of images of the plurality of types are, for example, the amount of scattered electrons different in scattering direction or the amount of scattered electrons different in energy turned into images. Specifically, with some electron microscopes, such images of a plurality of types can be imaged and acquired. With some of those electron microscopes, those images can be acquired by single imaging. With other devices, those images can be acquired with imaging divided into more than once. The SEM 101 of FIG. 1 is capable of capturing images of a plurality of types as described above using the plurality of detectors 111. As a result, a plurality of images of a plurality of types can be applied as a plurality of images in the three-dimensional direction in the fifth embodiment.

It should be noted that as for the plurality of images of input and output with respect to the model (first and estimated second learning images) in the configurations of FIGS. 4, 7, 9, and the like, the image counts on the input and output sides are equal to each other, but the present invention is not limited thereto and the image counts on the input and output sides may differ from each other. In addition, either the image count on the input side or the image count on the output side can be 1.

[5-2. Detector]

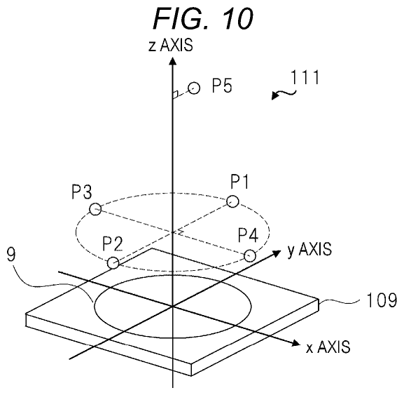

FIG. 10 is a perspective view illustrating a detailed configuration example of the plurality of detectors 111 of the SEM 101 of FIG. 1. In this example, five detectors are provided as the detectors 111. These detectors are disposed at predetermined positions (positions P1 to P5) with respect to the sample 9 on the stage 109. The z axis corresponds to the vertical direction. The detector at the position P1 and the detector at the position P2 are disposed at positions along the y axis, and the detector at the position P3 and the detector at the position P4 are disposed at positions along the x axis. These four detectors are disposed in the same plane at a predetermined position on the z axis. The detector at the position P5 is disposed along the z axis at a position separated above as compared with the planar positions of the four detectors.

The four detectors are disposed so as to be capable of selectively detecting electrons that have specific emission angles (elevation and azimuth angles). For example, the detector at the position P1 is capable of detecting electrons emitted from sample 9 along the positive direction of the y axis. The detector at the position P4 is capable of detecting electrons emitted from the sample 9 along the positive direction of the x axis. The detector at the position P5 is capable of detecting mainly electrons emitted from the sample 9 in the z-axis direction.

As described above, with the configuration in which the plurality of detectors are disposed at the plurality of positions along the different axes, it is possible to acquire an image with contrast as if light was emitted from a facing direction with respect to each detector. Accordingly, more detailed defect observation is possible. The configuration of the detector 111 is not limited thereto, and different numbers, positions, orientations, and so on may be configured.

[5-3. First Learning Image Created by Drawing Engine]

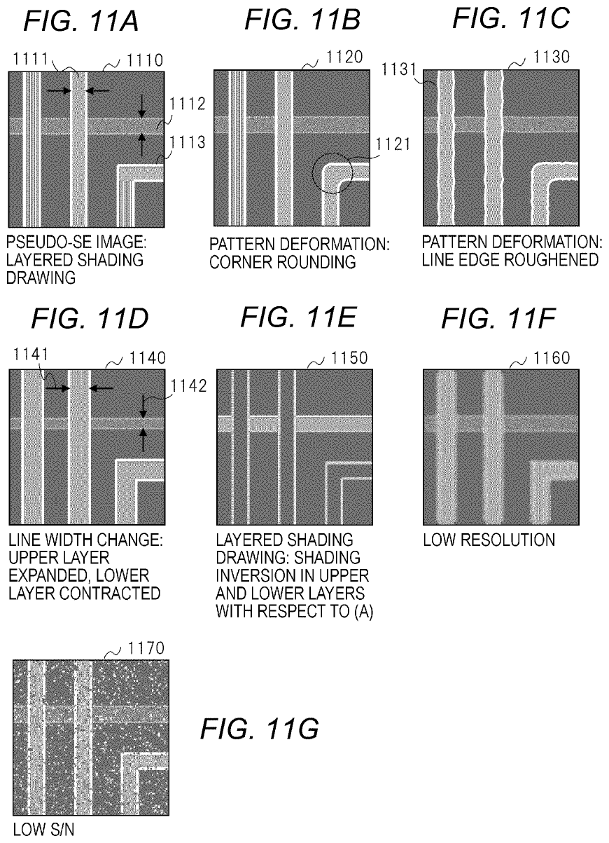

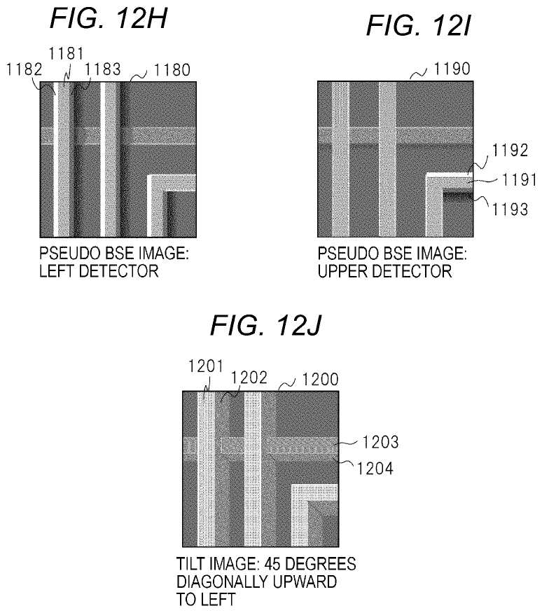

FIGS. 11 and 12 illustrate image examples of the first learning image 904 created by the drawing engine 903 in the learning phase S1 in the fifth embodiment. The plurality of types of images illustrated in FIGS. 11 and 12 are applicable in each embodiment. In the fifth embodiment, the processor creates these plurality of types of images by estimation based on the design data 900.

For example, a secondary electron image or a backscattered electron image can be obtained depending on the type of the electron ejected from the sample 9. Secondary electron is also abbreviated as SE. Backscattered electron is also abbreviated as BSE. FIGS. 11A to 11G are SE image examples, and FIGS. 12H to 121 are BSE image examples. FIGS. 11A to 11G are image examples in which image quality fluctuations are taken into consideration. FIGS. 11B to 11E are image examples in which pattern shape deformation is taken into consideration. In addition, as in the example of FIG. 10, in the case of a configuration that has a plurality of detectors (backscattered electron detectors) attached in several directions (e.g. up, down, left, and right on x-y plane), a BSE image for each direction can be obtained from the number of electrons detected by the plurality of detectors. In addition, in the case of a configuration in which an energy filter is provided in front of a detector, scattered electrons with a specific energy can be detected alone and an energy-specific image can be obtained as a result.

In addition, depending on the configuration of the SEM 101, it is possible to obtain a tilt image obtained by observing a measurement target from any inclination direction. The example of an image 1190 in FIG. 12J is a tilt image observed from a direction of 45 degrees diagonally upward to the left with respect to the surface of the sample 9 on the stage 109. Examples of how such a tilt image is obtained include a beam tilt method, a stage tilt method, and a lens barrel tilt method. By the beam tilt method, an electron beam emitted by an electron optical system is deflected and the irradiation angle of the electron beam is inclined to perform imaging. By the stage tilt method, imaging is performed with a sample-placed stage inclined. By the lens barrel tilt method, an optical system itself is inclined with respect to a sample.

In the fifth embodiment, such images of a plurality of types are used as the first learning images 904, and thus more information than in a configuration in which one image is used as the first learning image can be input to the model of the image quality conversion engine 905. Accordingly, it is possible to improve the performance of the model of the image quality conversion engine 905, particularly robustness allowing a response to various image qualities. The plurality of estimated second learning images 906 with different image qualities can be obtained as outputs of the model of the image quality conversion engine 905.

In addition, in the case of a configuration in which a plurality of different image quality conversion engines are prepared for each output image in order to use a plurality of images of different image qualities as outputs of the image quality conversion engine 905, it is necessary to optimize the plurality of image quality conversion engines. In addition, in using the image quality conversion engines, processing time increases as it is necessary to input a captured image into each image quality conversion engine and process the image. On the other hand, in the fifth embodiment, simply one image quality conversion engine 905 is sufficient in order to use a plurality of images of different image qualities (estimated second learning images 906) as outputs of the image quality conversion engine 905. In the fifth embodiment, the second learning image 907 is created based on the same design data 900, and thus the image quality conversion engine 905 is capable of creating each output image (estimated second learning image 906) from the same feature quantity. In this processing, using one image quality conversion engine 905 capable of outputting a plurality of images, processing during optimization and processing during image quality conversion are expedited and efficiency and convenience are improved.

An image 1110 of FIG. 11A is a layered shading drawing image as a pseudo SE image. As in the example of FIG. 5B described above, the region of the sample 9 has, for example, upper and lower layers as a circuit pattern. Image 1110 is an example of generation of an image quality variation by a pattern shading value. The processor creates such an image by changing the pattern shading value based on the region of the design data. In this image 1110, the upper layer line (e.g. line region 1111) and the lower layer line (e.g. line region 1112) are drawn to be different in shading (brightness) and the upper layer is brighter than the lower layer. In addition, as in the example of an image 1101, in the image, the white band in the edge portion (e.g. line 1113) of each layer, which is particularly conspicuously observed in the SE image, may be drawn.

An image 1120 in FIG. 11B is an example resulting from circuit pattern shape deformation. The processor creates such an image by circuit pattern shape deformation processing based on the region of design data. The image 1120 is corner rounding as an example of shape deformation. A corner 1211 of the vertical and horizontal lines is rounded.

An image 1130 in FIG. 11C is an example of line edge roughening as another shape deformation example. The image 1130 is roughened for each line region such that the edge (e.g. line 1131) is distorted.

An image 1140 in FIG. 11D is a line width change example as another shape deformation example. In the image 1140, the line width of the line region of the upper layer (e.g. line width 1141) is expanded more than the standard and the line width of the line region of the lower layer (e.g. line width 1412) is contracted more than the standard.

An image 1150 in FIG. 11E is an example in which the shading (brightness) is inverted in the upper and lower layers with respect to the image 1110 in FIG. 11A as another layered shading drawing example. In the image 1150, the lower layer is brighter than the upper layer.

An image 1160 in FIG. 11F is an example of image quality variation by image resolution. The processor creates such an image by resolution change processing based on the region of design data. The image 1160 is lower in resolution than the standard with a low-resolution microscope assumed. The image 1160 is blurred. For example, the edge of the line region is blurred.

An image 1170 in FIG. 11G is an example of image quality variation by image noise. The processor creates such an image by image noise change processing based on the region of design data. The image 1170 is lower in S/N than the standard by noise addition. In the image 1170, noise for each pixel (different shading values) appears.

In FIG. 12H, an image 1180 is an example of image quality variation by a detector in a pseudo BSE image example. The processor creates such an image by, for example, image processing based on the configuration of the detector 111 and the region of design data. The image 1180 is an image in which a shadow is on the right side of the circuit pattern with an image by, for example, a left BSE detector as one of a plurality of detectors assumed. For example, regarding a vertical line region 1181, there are a left edge line 1182 and a right edge line 1183. The left edge line 1182 is brighter in color (representation as if illuminated) with a case where a BSE detector is on the left side with respect to this pattern assumed. On the other hand, the right edge line 1183 is darker in color (shadow-like representation).

The image 1190 in FIG. 12I is another example by a detector and an image in which an image by an upper BSE detector is assumed and there is a shadow on the lower side of the pattern. For example, regarding a certain horizontal line region 1191, there are an upper edge line 1192 and a lower edge line 1193. The upper edge line 1192 is brighter in color with a case where a BSE detector is on the upper side with respect to this pattern assumed. On the other hand, the lower edge line 1193 is darker in color.

An image 1200 in FIG. 12J is a tilt image example. The image 1200 is a tilt image assuming a case where the sample 9 (FIG. 10) on the stage 109 is imaged from an obliquely upward direction, for example, 45 degrees diagonally upward to the left (tilt direction), instead of the standard z-axis direction. In this tilt image, a pattern is represented three-dimensionally. For example, in the pattern of a vertical line region 1201, a right side surface region 1202 is represented assuming the case of oblique observation. A lower side surface region 1204 is represented in a horizontal line region 1203. Also represented is a part where the vertical line region 1201 in the upper layer and the horizontal line region 1204 in the lower layer intersect.

The processor estimates and creates such a tilt image from, for example, two-dimensional pattern layout data in design data. At this time, examples of how the tilt image is estimated and created include inputting a pattern height design value to generate a pseudo-pattern three-dimensional shape and estimate the image observed from the tilt direction.

As described above, the processor of the sample observation device 1 creates images of various different image qualities as variations and uses the images as the first learning images 904, which are a plurality of input images, by taking into consideration image quality fluctuations assumed in imaging the sample 9 due to the effect of the state of the sample 9, imaging conditions, or the like such as charging and pattern shape fluctuation. As a result, it possible to optimize the model of the image quality conversion engine 905 to be robust against the image quality fluctuation of an input image. In addition, the model can be optimized with high accuracy by setting the detector 111 of the imaging device 2 (e.g. detector used among detectors) in accordance with conditions in observing the sample 9 or by making a tilt image.

[5-4. Second Learning Image Created by Drawing Engine]

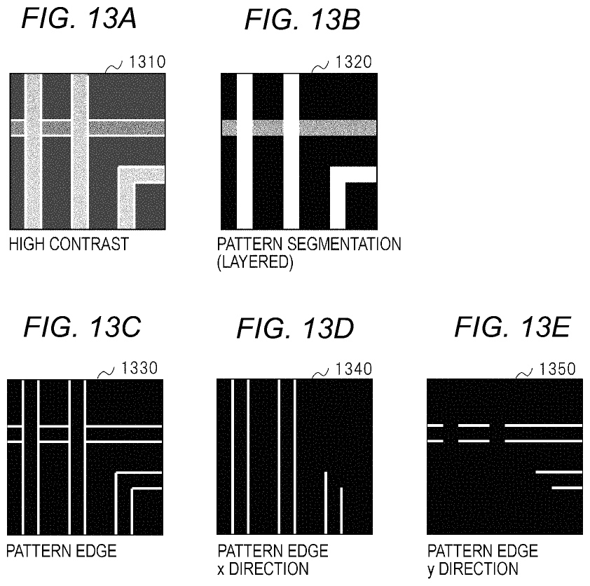

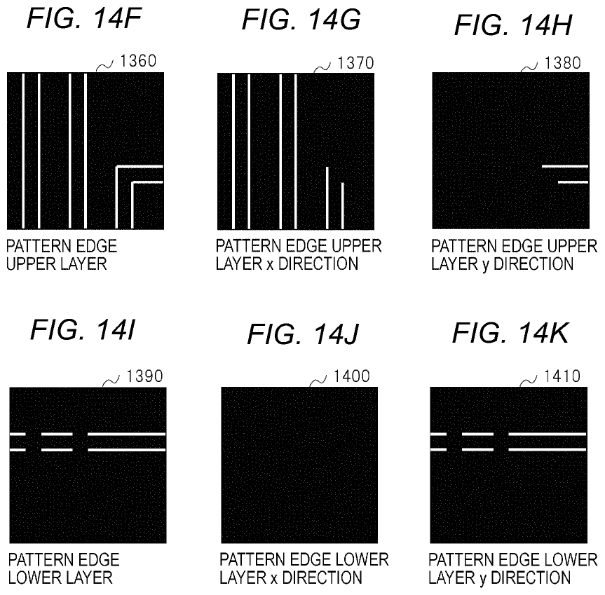

Next, FIGS. 13 and 14 illustrate examples of the second learning image 907 created by the drawing engine 903. For example, the second learning image 907 may be a high-contrast and high-S/N image improved in visibility as compared with an image obtained by imaging. In addition, the second learning image 907 may be an image matching user preference such as a tilt image. In addition, the second learning image 907 may be the result of applying image processing for acquiring information from an image to be obtained by imaging as well as an image imitating a captured image. In addition, the second learning image 907 may be an image obtained by extracting a part from the circuit pattern of design data.

In FIG. 13A, an image 1310 is an example of a high-contrast image improved in visibility as compared with an image obtained by imaging. In the image 1310, the three types of regions of an upper layer pattern region, a lower layer pattern region, and the other region (pattern-less region) are represented so as to be high in contrast.

An image 1320 in FIG. 13B is an example of a layered pattern segmentation image. In the image 1320, the three types of regions of an upper layer pattern region, a lower layer pattern region, and the other region (pattern-less region) are represented with different region-specific colors.

The images from an image 1330 in FIG. 13C to an image 1410 in FIG. 14K are pattern edge image examples, in which conspicuous pattern contour lines (edges) are drawn. In the image 1330 in FIG. 13C, the edge of a pattern is extracted. For example, the edge line of each line region is drawn in white with the rest drawn in black.

The image 1340 in FIG. 13D and the image 1350 in FIG. 13E are images by edge direction with respect to the image 1330 in FIG. 13C. In the image 1340 in FIG. 13D, only the edge in the x direction (lateral direction) is extracted. In the image 1350 in FIG. 13E, only the edge in the y direction (longitudinal direction) is extracted.

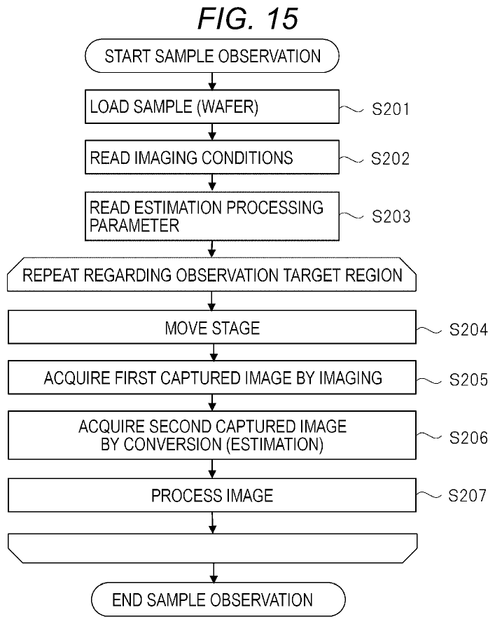

In FIG. 14, the images from the image 1360 in FIG. 14F to the image 1410 in FIG. 14K are image examples divided by semiconductor stacking layer. In the image 1360 in FIG. 14F, only the edge of the upper layer pattern is extracted. In the image 1370 in FIG. 14G, only the x-direction edge of the upper layer pattern is extracted. In the image 1380 in FIG. 14H, only the y-direction edge of the upper layer pattern is extracted. In the image 1390 in FIG. 14I, only the edge of the lower layer pattern is extracted. In the image 1400 in FIG. 15J, only the x-direction edge of the lower layer pattern is extracted. In the image 1410 in FIG. 14K, only the y-direction edge of the lower layer pattern is extracted.

In a case where image processing is applied to a captured image, correct information extraction may be impossible due to the effect of image noise or the like or a parameter may need to be adjusted in accordance with the application process. In the fifth embodiment, when a post-image processing application image is acquired from design data, noise or the like has no effect, and thus information can be acquired with ease. In the fifth embodiment, an image to which image processing for acquiring information from an image to be obtained by imaging is applied is learned as the second learning image 907 to optimize the model of the image quality conversion engine 905. As a result, it is possible to use the image quality conversion engine 905 instead of image processing.

It should be noted that although the edge images in this example are a plurality of direction-specific edge images in the two directions of x and y, the present invention is not limited thereto and similar application is possible regarding another direction (e.g. in-plane diagonal direction) as well.

<Sample Observation Phase>

An example of the sample observation phase S2 of FIG. 2 will be described with reference to FIG. 15. The processing examples starting from FIG. 15 can be similarly applied to each of the embodiments described above. FIG. 15 illustrates the processing flow of the sample observation phase S2 and includes steps S201 to S207. First, in step S201, the processor of the higher control device 3 loads a semiconductor wafer that is the sample 9 to be observed onto the stage 109 of the SEM 101. In step S202, the processor reads imaging conditions corresponding to the sample 9. In addition, in step S203, the processor reads a processing parameter (model parameter 270 learned in the learning phase S1 of FIG. 2 and optimized for image estimation) of the image quality conversion engine (e.g. image quality conversion engine 405 of FIG. 4) corresponding to the sample observation processing (estimation processing S21).

Next, in step S204, the processor moves the stage 109 such that the observation target region on the sample 9 is included in the imaging field of view. In other words, the processor positions the imaging optical system in the observation target region. The processing of steps S204 to S207 is loop processing repeated for each observation target region (e.g. defect position indicated by defect position information 8). Next, in step S205, the processor irradiates the sample 9 with an electron beam under the control of the SEM 101 and acquires the first captured image 253 (F) of the observation target region by detecting, for example, secondary or backscattered electrons with the detector 111 and performing conversions into an image.

Next, in step S206, the processor acquires a second captured image 254 (G′) by estimation as an output by inputting the first captured image 253 (F) to the image quality conversion engine 405 (model 260 of estimation unit 240 of FIG. 2). As a result, the processor is capable of acquiring the second captured image 254 obtained by converting the image quality of the first captured image 253 into the image quality of the second learning image. In other words, an image of an image quality suitable for observation processing (observation image) is obtained as the second captured image 254.

Then, in step S207, the processor may apply image processing corresponding to the purpose of observation to the second captured image 254. Examples of this image processing application include dimension measurement, alignment with design data, and defect detection and identification. Each example will be described later. It should be noted that such image processing may be performed by a device other than the sample observation device 1 (e.g. defect classification device 5 of FIG. 1).

<A. Dimension Measurement>

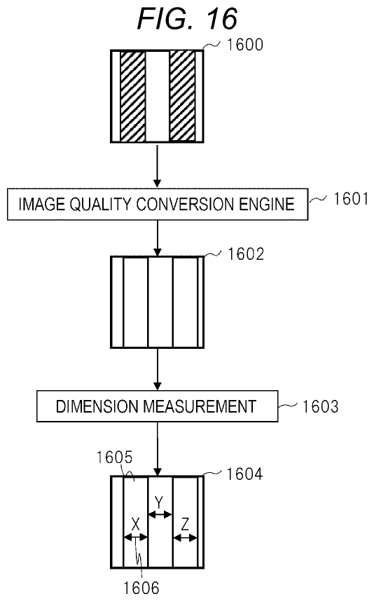

An example of the dimension measurement processing as an example of the image processing in step S207 is as follows. FIG. 16 illustrates the example of the dimension measurement processing. In this dimension measurement, the dimension of the circuit pattern of the sample 9 is measured using the second captured image 254 (F′). The processor of the higher control device 3 uses an image quality conversion engine 1601 pre-optimized using an edge image (FIGS. 13 and 14) as the second learning image. The processor acquires an image 1602, which is an edge image, as an output by inputting an image 1600, which is the first captured image 253 (F), to the image quality conversion engine 1601.

Next, the processor performs dimension measurement processing 1603 with respect to the image 1602. In this dimension measurement processing 1603, the processor performs pattern dimension measurement by inter-edge distance measurement. The processor obtains an image 1604, which is the result of the dimension measurement processing 1603. In the examples of the images 1602 and 1604, lateral width measurement is performed for each inter-edge region. The examples include a breadth (X) 1606 of an inter-edge region 1605.

Further, the edge image as described above is effective for two-dimensional pattern shape evaluation based on a pattern contour line as well as a one-dimensional pattern dimension represented by the line width and hole diameter described above. For example, in a lithography process in semiconductor manufacturing, an optical proximity effect may lead to two-dimensional pattern shape deformation. Examples of the shape deformation include a rounded corner portion and an undulating pattern.

In performing pattern dimension and shape measurement and evaluation from an image, it is necessary to specify a pattern edge position with as high accuracy as possible by image processing. However, an image obtained by imaging also includes information other than pattern information such as noise. Accordingly, in order to specify an edge position with high accuracy, it is necessary in the related art to manually adjust an image processing parameter. On the other hand, in this processing, the image quality conversion engine (model) pre-optimized by learning converts a captured image into an edge image, and thus an edge position can be specified with high accuracy without manual image processing parameter adjustment. In the model learning, learning and optimization are performed using images of various image qualities in which edges, noise, and so on are taken into consideration as input-output images. Accordingly, it is possible to perform high-accuracy dimension measurement using a suitable edge image (second captured image 254) as described above.

<B. Alignment with Design Data>

An example of the processing of alignment with design data as an example of the image processing in step S207 is as follows. In an electron microscope such as the SEM 101, it is necessary to estimate and correct (i.e. address) an imaging position deviation amount. An electron beam irradiation position needs to be moved in order to move the field of view of the electron microscope. There are two methods therefor, one is a stage shift by which a sample-transporting stage is moved, the other is an image shift by which a deflector changes the trajectory of an electron beam, and each entails a stop position error.

As a method for imaging position deviation amount estimation, it is conceivable to perform alignment (i.e. matching) between a captured image and design data (region therein). Meanwhile, in a case where the image quality of the captured image is poor, the alignment itself may fail. Accordingly, in the embodiment, the imaging position of the first captured image 253 is specified by performing alignment between design data (region therein) and the second captured image 254, which is an output when the captured image (first captured image 253) is input to the image quality conversion engine (model 270). Several image conversion methods are conceivable as methods effective for the alignment. For example, in one method, an image higher in picture quality than the first captured image 253 is estimated as the second captured image 254. As a result, an improvement in alignment success rate can be anticipated. In addition, in another method, it is conceivable to estimate a direction-specific edge image as the second captured image 254.

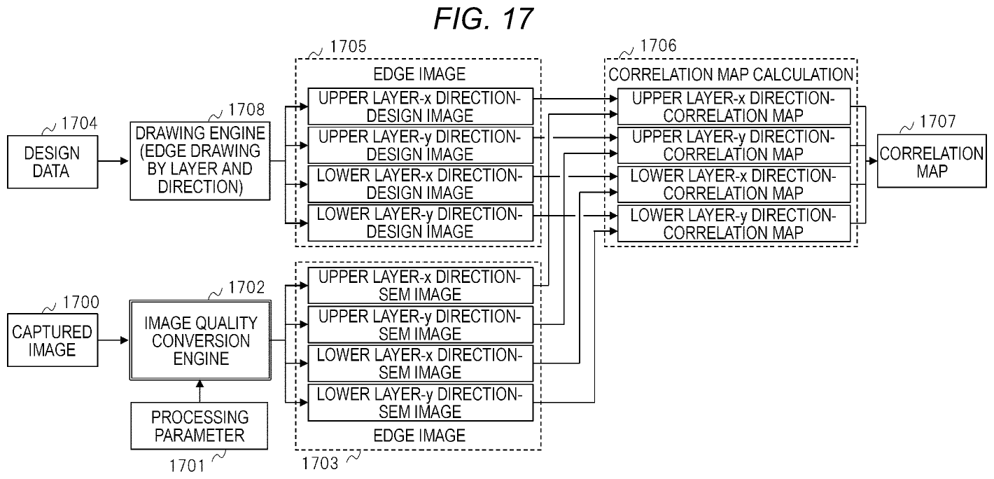

FIG. 17 illustrates an example of the processing of alignment with design data. The processor sets a processing parameter 1701 pre-optimized using the edge image in each direction of each layer of the pattern of the sample 9 as the second learning image in an image quality conversion engine 1002. The processor inputs a captured image 1700, which is the first captured image 253, to an image quality conversion engine 1702 to obtain an edge image (image group) 1703, which is the second captured image 254, as an output. The edge image (image group) 1703 is an edge image (estimated SEM image) of each pattern layer and direction, examples of which include images in the upper layer x and y directions and the lower layer x and y directions. An example of an image of an image quality corresponding thereto is as in, for example, FIG. 13 described above.

Next, the processor draws the region of the sample 9 in design data 1704 with a drawing engine 1708 and creates an edge image (image group) 1705 for each layer and edge direction. The edge image (image group) 1705 is an edge image (design image) created from the design data 1704. Similarly to the edge image 1703, examples thereof include images in the upper layer x and y directions and the lower layer x and y directions.

Next, the processor calculates 1706 each correlation map between the edge image 1705 created from the design data 1704 and the edge image 1703 created from the captured image 1700. In this correlation map calculation 1706, the processor creates a correlation map for each set of images corresponding in layer and direction with each image of the edge image 1703 and each image of the edge image 1705. As the plurality of correlation maps, for example, correlation maps in the upper layer x and y directions and the lower layer x and y directions can be obtained. Next, the processor calculates and obtains a final correlation map 1707 by combining the plurality of correlation maps into one by performing weighted addition or the like.

In this final correlation map 1707, the position of maximum correlation value is the position of alignment (matching) between the captured image (corresponding observation target region) and the design data (corresponding region therein). In the weighted addition, for example, the weight is inversely proportional to the amount of the edge in the image. As a result, correct alignment can be anticipated without sacrificing the degree of matching of an image with a small edge amount.

As described above, the captured image and the design data can be aligned with high accuracy using the pattern shape-indicating edge image. However, the captured image also includes information other than pattern information as described above, and thus image processing parameter adjustment needs to be performed in order to highly accurately specify an edge position from the captured image by image processing. In this processing, the pre-optimized image quality conversion engine converts the first captured image into an edge image, and thus an edge position can be specified with high accuracy without manual parameter adjustment. As a result, the alignment between the captured image and the design data can be realized with high accuracy.

<C. Defect Detection and Defect Type Identification>

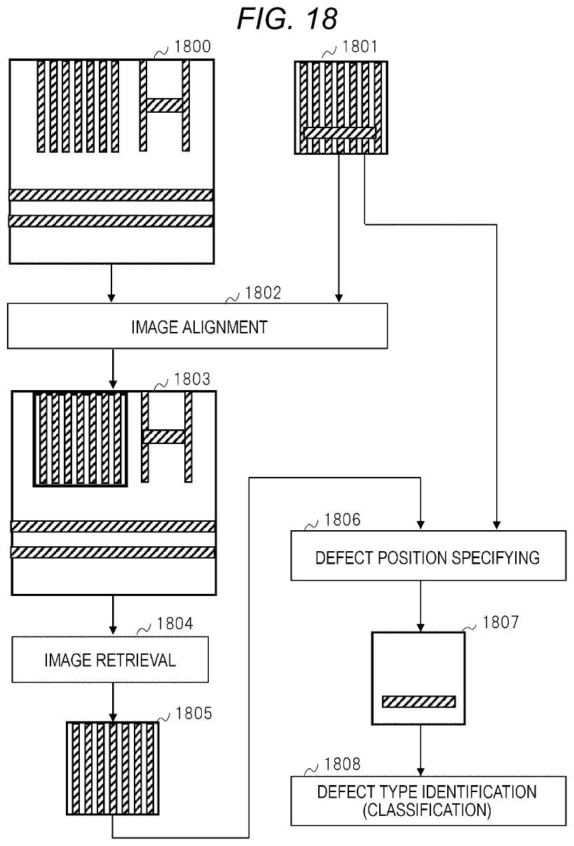

An example of the processing of defect detection and defect type identification (classification) as an example of the image processing in step S207 is as follows. FIG. 18 illustrates the example of the processing of defect detection and defect type identification (classification). The processor uses an image quality conversion engine optimized using a high-S/N image as the second learning image. The processor acquires an alignment result image 1803 by performing image alignment processing 1802 between an image 1801, which is the second captured image 254 obtained by the image quality conversion engine based on a captured image, and a reference image 1800 created from design data.

Next, the processor acquires a cut-out image 1805 by performing processing 1804 to cut out the same region as the image 1801 obtained based on the captured image from the alignment result image 1803 based on the design data.

Next, the processor performs defect position specifying processing 1806 by calculating the difference between the cut-out image 1805 and the image 1801 obtained based on the captured image to obtain an image (defect image) 1807 including a specified defect position as the result thereof.

Subsequently, the processor may further apply processing 1808 (i.e. classification processing) to perform defect type identification using the defect image 1807. As a method for the defect identification, a feature quantity may be calculated from an image by image processing and identification may be performed based on the feature quantity or identification may be performed using a pre-optimized CNN for defect identification.

In general, the reference image and the first captured image obtained by imaging include noise, and thus it is necessary in the related art to perform manual image processing parameter adjustment in order to perform defect detection and identification with high accuracy. On the other hand, in this processing, the image quality conversion engine converts the first captured image into the high-S/N image 1801 (second captured image 254), and thus the effect of noise can be reduced. In addition, the reference image 1800 created from the design data is noise-free, and thus it is possible to specify a defect position without taking reference image noise into consideration. In this manner, it is possible to reduce the effect of noise in the first captured and reference images, which is a hindrance in specifying a defect position.

<GUI>

Next, a GUI screen example that can be similarly applied to each of the embodiments will be described. It should be noted that the configurations of the first to third embodiments and so on can be combined and, in the combined configurations, a suitable configuration to be appropriately used by a user can be selected from the configurations of the first to third embodiments and so on. The user can select, for example, a model in accordance with the type of sample observation or the like.

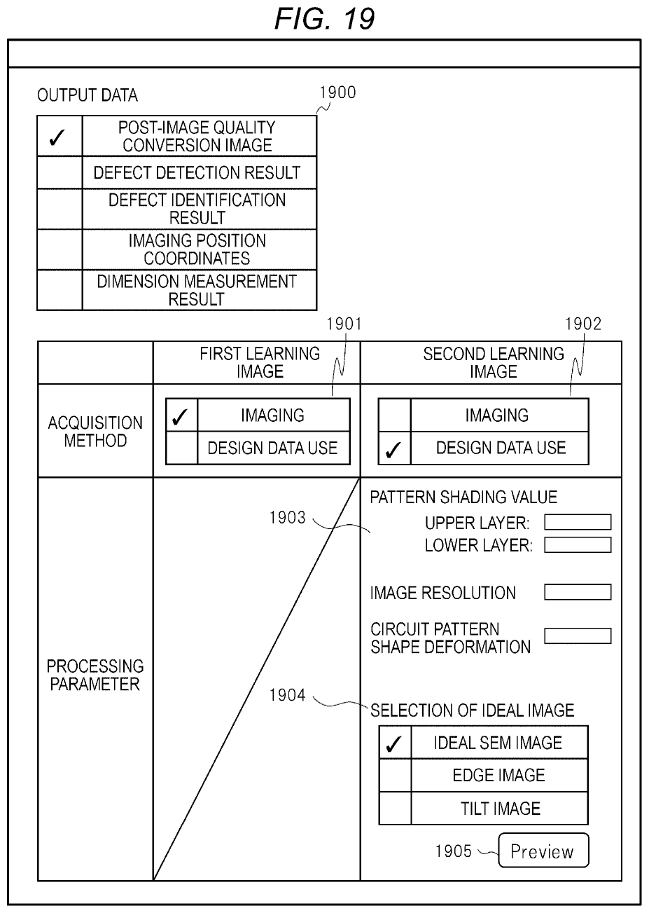

FIG. 19 illustrates an example of a GUI screen that can be determined and set by a user with regard to the engine (model) optimization method described above. On this screen, the user can select and set the type of output data in an output data column 1900. Displayed in the column 1900 are options such as a post-image quality conversion image and various image processing application results (e.g. defect detection result, defect identification result, imaging position coordinates, and dimension measurement result).

In addition, the lower table is provided with a column in which the user can set an acquisition method and a processing parameter regarding the first learning image and the second learning image related to the learning phase S1 described above. In a column 1901, a first learning image acquisition method can be set by selection from the options of “imaging” and “design data use”. In a column 1902, a second learning image acquisition method can be set by selection from the options of “imaging” and “design data use”. In the example of FIG. 19, “imaging” is selected in the column 1901 and “design data use” is selected in the column 1902, which corresponds to the configuration of the second embodiment.

In a case where “design data use” is selected in the second learning image acquisition method, in the corresponding processing parameter column, the user can designate and set a processing parameter to be used in the engine. In a column 1903, as an example of the parameter, the values of parameters such as pattern shading value, image resolution, and circuit pattern shape deformation can be designated.

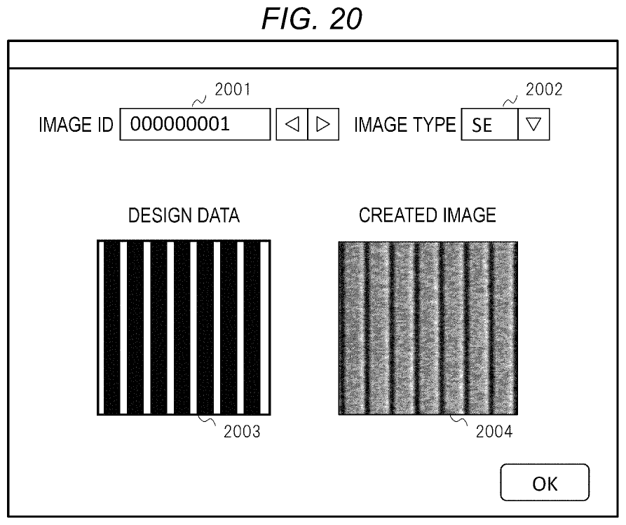

In addition, in a column 1904, the user can select an image quality of an ideal image from the options. The image quality of the ideal image (target image, second learning image) can be selected from, for example, an ideal SEM image, an edge image, a tilt image, and the like. In a case where a preview button 1905 is pressed after the image quality of the ideal image is selected, a preview image of the selected image quality can be confirmed on, for example, the screen of FIG. 20.

In the screen example of FIG. 20, the preview image of the selected image quality is displayed. In an image ID column 2001, the user can select the ID of the image to be previewed. In an image type column 2002, the user can select a target image type from the options. In a column 2003, a preview image of design data (region therein) input for creating a learning image (second learning image in this example) is displayed. In a column 2004, in a case where a processing parameter (FIG. 19) set by the user for creating the learning image (second learning image in this example) is set in the drawing engine, an image created and output by the drawing engine is displayed as a preview image. On this screen, the image of the column 2003 and the image of the column 2004 are displayed in parallel. The user can confirm the images. The first learning image can also be previewed in the same manner.

Although single design data (region of sample 9) and an image created corresponding thereto are displayed in this example, similarly, an image can be displayed by designating another region with an image ID or predetermined operation. In a case where an SEM image is selected as an ideal image in the column 1904 of FIG. 19, in the column 2002, it is possible to select, for example, which detector of the detectors 111 the image corresponds to in type as the image type. In a case where an edge image is selected as an ideal image, it is possible to select, for example, which layer and which direction of the edge information the image corresponds to as the image type. Using the GUI as described above, work by a user can be made more efficient.

Although the present invention has been specifically described above based on the embodiments, the present invention is not limited to the embodiments and can be variously modified without departing from the gist.

What is claimed is:

1. A sample observation device comprising an imaging device and a processor,
wherein the processor:
stores design data on a sample in a storage resource;
creates a first learning image as a plurality of input images;
creates a second learning image as a target image;
learns a model related to image quality conversion with the first and second learning images;
acquires, as an observation image, a second captured image output by inputting a first captured image obtained by imaging the sample with the imaging device to the model in observing the sample; and
creates at least one of the first and second learning images based on the design data.

2. The sample observation device according to claim 1,
wherein the processor:
creates the first learning image based on the design data; and
creates the second learning image based on the design data.

3. The sample observation device according to claim 1,
wherein the processor:
creates the first learning image based on a captured image obtained by imaging the sample with the imaging device; and
creates the second learning image based on the design data.

4. The sample observation device according to claim 1,
wherein the processor:
creates the first learning image based on the design data; and
creates the second learning image based on a captured image obtained by imaging the sample with the imaging device.

5. The sample observation device according to claim 1, wherein
the first learning image includes a plurality of images of a plurality of image qualities, and
the plurality of images of the plurality of image qualities are created by a change in at least one element among circuit pattern shading, shape deformation, image resolution, and image noise of the sample.

6. The sample observation device according to claim 1, wherein
the second learning image is created using a parameter value designated by a user, and
a parameter designatable by the user is a parameter corresponding to at least one element among circuit pattern shading, shape deformation, image resolution, and image noise of the sample.

7. The sample observation device according to claim 3,
wherein the processor collates the captured image with the design data and trims an image of a region of a corresponding position in the captured image from a region of the design data.

8. The sample observation device according to claim 1,
wherein the processor:
creates a plurality of images for each same region of the sample as the first learning image;
creates a plurality of images for each of the same regions of the sample as the second learning image;
at a time of the learning, learns the model with the plurality of images of the first learning image and the plurality of images of the second learning image for each of the same regions of the sample; and
in observing the sample, acquires, as the observation image, a plurality of captured images as the second captured image output by inputting, to the model, a plurality of captured images captured for each of the same regions of the sample as the first captured image obtained by imaging the sample with the imaging device.

9. The sample observation device according to claim 8,
wherein the plurality of captured images in the first captured image are a plurality of types of images acquired by a plurality of detectors of the imaging device, in which the amount of scattered electrons different in scattering direction or energy is detected.

10. The sample observation device according to claim 1,
wherein, in creating the second learning image based on the design data, the processor creates an edge image in which a pattern contour line of the sample is drawn from a region of the design data.

11. The sample observation device according to claim 10,
wherein the processor:
in creating the edge image, creates a plurality of edge images in which direction-specific pattern contour lines in a plurality of directions are drawn from a region of the design data; and
at a time of the learning, learns the model with the first learning image and a plurality of images corresponding to the plurality of edge images as the second learning image.

12. The sample observation device according to claim 1,
wherein the processor measures a circuit pattern dimension of the sample using the observation image in observing the sample.

13. The sample observation device according to claim 1,
wherein the processor specifies an imaging position of the first captured image by performing alignment between the observation image and the design data using the observation image in observing the sample.

14. The sample observation device according to claim 1,
wherein the processor specifies a position of a defect of the sample using the observation image by the second captured image output by inputting the first captured image obtained by imaging defect coordinates indicated by defect position information to the model in observing the sample.

15. The sample observation device according to claim 1,
wherein the processor:
at a time of the learning, uses at least one of the first and second learning images as a tilt image obtained by observing a surface of the sample from diagonally above based on the design data; and
in observing the sample, acquires, as the observation image, a tilt image as the second captured image output by inputting a tilt image obtained by imaging the surface of the sample from diagonally above with the imaging device to the model as the first captured image.

16. The sample observation device according to claim 1,
wherein the processor causes the first or second learning image created based on the design data to be displayed on a screen.

17. A sample observation method in a sample observation device including an imaging device and a processor, the method comprising as steps executed by the processor:
a step of storing design data on a sample in a storage resource;
a step of creating a first learning image as a plurality of input images;
a step of creating a second learning image as a target image;
a step of learning a model related to image quality conversion with the first and second learning images;
a step of acquiring, as an observation image, a second captured image output by inputting a first captured image obtained by imaging the sample with the imaging device to the model in observing the sample; and
a step of creating at least one of the first and second learning images based on the design data.

18. A computer system in a sample observation device including an imaging device,
wherein the computer system:
stores design data on a sample in a storage resource;
creates a first learning image as a plurality of input images;
creates a second learning image as a target image;
learns a model related to image quality conversion with the first and second learning images;
acquires, as an observation image, a second captured image output by inputting a first captured image obtained by imaging the sample with the imaging device to the model in observing the sample; and
creates at least one of the first and second learning images based on the design data.

19. The sample observation device according to claim 4,
wherein the processor collates the captured image with the design data and trims an image of a region of a corresponding position in the captured image from a region of the design data.
